(19) United States
(12) Patent Application Publication
(10) Pub. No.: US 2025/0206430 A1
(43) Pub. Date: Jun. 26, 2025

(54) SYSTEM AND METHOD FOR OPERATING AN ELECTRIC VEHICLE BASED ON ACCELERATOR ACTUATION RATE

(71) Applicant: TAIGA MOTORS INC., Lasalle (CA)

(72) Inventor: Sean DURAND, Montreal (CA)

(21) Appl. No.: 18/983,978

(22) Filed: Dec. 17, 2024

Related U.S. Application Data
(60) Provisional application No. 63/612,402, filed on Dec. 20, 2023.

(51) Int. Cl. B63H 21/21; B60L 15/20; B63H 21/17

(52) U.S. Cl. CPC B63H 21/21; B60L 15/20; B63H 21/17; B60L 2200/32; B60L 2240/12; B60L 2250/26; B63H 2021/216

(57) ABSTRACT

A method of operating an electric vehicle includes receiving, via an operator-actuated accelerator of the electric vehicle, a propulsion command for propelling the electric vehicle. When an actuation rate of the accelerator associated with the propulsion command is a first value, the electric vehicle is accelerated at a first acceleration. When the actuation rate of the accelerator associated with the propulsion command is a second value higher than the first value, the electric vehicle is accelerated at a second acceleration higher than the first acceleration.

### CROSS-REFERENCE TO RELATED APPLICATION AND CLAIM OF PRIORITY

The present application claims priority to U.S. provisional patent application No. 63/612,402 filed on Dec. 20, 2023, the entire contents of which are hereby incorporated herein by reference.

### TECHNICAL FIELD

The disclosure relates generally to electric vehicles, and more particularly to operating electric vehicles.

### BACKGROUND

Some vehicles have different operating modes tailored to provide different user experiences. From an energy consumption and range perspective, it is desirable to operate the vehicle in an economy or power-saving operating mode. However, operating the vehicle in the economy or power-saving operating mode limits the responsiveness of the vehicle and can cause the vehicle to feel sluggish. In some situations, this can cause the user to switch to a less restrictive operating mode that increases energy consumption and reduces range. Improvement is desirable.

### SUMMARY

In one aspect, the disclosure describes a method of operating an electric vehicle. The method comprises:
receiving, via an operator-actuated accelerator of the electric vehicle, a propulsion command for propelling the electric vehicle, the propulsion command being indicative of an accelerator position and an actuation rate of the accelerator to the accelerator position, the propulsion command corresponding to a first acceleration when the actuation rate is lower than an actuation rate threshold and to a second acceleration when the actuation rate is higher than the actuation rate threshold, the second acceleration being greater than the first acceleration;
determining that the actuation rate is higher than the actuation rate threshold; and
responsive to the determining and with the accelerator at the accelerator position, causing the electric vehicle to accelerate at the second acceleration.

The electric vehicle may be a watercraft. The propulsion command may be received when the watercraft is in an operating mode imposing a power output limit for a powertrain of the watercraft. Causing the watercraft to accelerate at the second acceleration may include causing the powertrain of the watercraft to generate a power output higher than the power output limit while remaining in the operating mode.

The first acceleration may correspond to a power output equal to or lower than the power output limit.

The actuation rate threshold may be a first actuation rate threshold. The propulsion command may further correspond to a third acceleration when the actuation rate of the accelerator is higher than a second actuation rate threshold higher than the first actuation rate threshold. The method may include determining that the actuation rate is lower than the second actuation rate threshold.

The accelerator position may be indicative of a commanded speed of the electric vehicle. Causing the electric vehicle to accelerate at the second acceleration may include causing the electric vehicle to exceed the commanded speed.

The method may comprise, after causing the electric vehicle to exceed the commanded speed and while the accelerator remains at the accelerator position, causing the electric vehicle to decelerate to the commanded speed.

The commanded speed of the watercraft may be a planing speed of the watercraft.

The propulsion command may include a displacement of the accelerator from a first accelerator position to a second accelerator position. The method may include determining the actuation rate of the accelerator by dividing the displacement of the accelerator by an amount of time taken to execute the displacement of the accelerator.

The propulsion command may include a displacement of the accelerator from a first accelerator position to a second accelerator position. Causing the electric vehicle to accelerate at the second acceleration may be conditional upon the displacement of the accelerator being higher than a displacement threshold.

The propulsion command may include a displacement of the accelerator from a first accelerator position to a second accelerator position. Causing the electric vehicle to accelerate at the second acceleration higher than the first acceleration may be conditional upon the first accelerator position being lower than a position threshold.

The method may comprise determining the actuation rate of the accelerator by dividing the displacement of the accelerator by an amount of time taken to execute the displacement of the accelerator.

The electric vehicle may be a personal watercraft or a snowmobile.

Embodiments may include combinations of the above features.

In another aspect, the disclosure describes a computer program product for controlling an operation of an electric powersport vehicle, the computer program product comprising a non-transitory computer readable storage medium having program code embodied therewith, the program code readable and executable by a computer, processor or logic circuit to perform one or more methods described herein.

In another aspect, the disclosure describes a system for operating an electric vehicle. The system comprises:
an accelerator actuatable by an operator of the electric vehicle to generate a propulsion command including an accelerator position and an actuation rate of the accelerator to the accelerator position; and
one or more controllers operatively connected to the accelerator and to a powertrain of the electric vehicle, the one or more controllers being configured to:
receive the propulsion command;
with the accelerator at the accelerator position, execute the propulsion command by:
when the actuation rate of the accelerator is a first value, cause the powertrain of the electric vehicle to generate a first power output to accelerate the electric vehicle; and
when the actuation rate of the accelerator is a second value higher than the first value, cause the powertrain of the electric vehicle to generate a second power output to accelerate the electric vehicle, the second power output being higher than the first power output.

The propulsion command may be received when the electric vehicle is in an operating mode imposing a power output limit for the powertrain of the electric vehicle. The second power output may be higher than the power output limit.

The propulsion command may be received when the electric vehicle is in the operating mode imposing the power output limit for the powertrain of the electric vehicle. The first power output may be equal to or lower than the power output limit.

The accelerator position may be indicative of a commanded operating speed of an electric motor configured to propel the electric vehicle. Causing the powertrain of the electric vehicle to generate the second power output to accelerate the electric vehicle may include causing the electric motor to exceed the commanded operating speed while executing the propulsion command.

The one or more controllers may be configured to, after causing the electric motor to exceed the commanded operating speed, causing the electric motor to decelerate to the commanded operating speed while executing the propulsion command.

Embodiments may include combinations of the above features.

In another aspect, the disclosure describes a watercraft comprising a system as described herein.

In another aspect, the disclosure describes a snowmobile comprising a system as described herein.

In another aspect, the disclosure describes an electric vehicle comprising:
a powertrain including an electric motor for propelling the electric vehicle and a battery operatively connected to drive the electric motor;
an accelerator actuatable by an operator of the electric vehicle;
one or more controllers operatively connected to the powertrain and to the accelerator, the one or more controllers being configured to:
receive a propulsion command via the accelerator, the propulsion command being indicative of an accelerator position and an actuation rate of the accelerator to the accelerator position;
with the accelerator at the accelerator position, executing the propulsion command by:
when the actuation rate of the accelerator is a first value, command the powertrain of the electric vehicle to generate a first power output to accelerate the electric vehicle; and
when the actuation rate of the accelerator is a second value higher than the first value, command the powertrain of the electric vehicle to generate a second power output to accelerate the electric vehicle, second power output being higher than the first power output.

When the propulsion command is received when the electric vehicle is in an operating mode imposing a power output limit for the powertrain of the electric vehicle, the second power output may be higher than the power output limit.

When the propulsion command is received when the electric vehicle is in the operating mode imposing the power output limit for the powertrain of the electric vehicle, the first power output may be equal to or lower than the power output limit.

The propulsion command may be indicative of a commanded operating speed of the electric motor. Causing the powertrain of the electric vehicle to generate the second power output to accelerate the electric vehicle may include causing the electric motor to exceed the commanded operating speed while executing the propulsion command.

The one or more controllers may be configured to, after causing the electric motor to exceed the commanded operating speed, cause the electric motor to decelerate to the commanded operating speed while executing the propulsion command.

The electric vehicle may be a personal watercraft or a snowmobile.

Embodiments may include combinations of the above features.

In another aspect, the disclosure describes a method of operating an electric vehicle. The method comprises:
receiving, via an operator-actuated accelerator of the electric vehicle, a propulsion command for propelling the electric vehicle, the propulsion command being indicative of an accelerator position and an actuation rate of the accelerator to the accelerator position, the propulsion command corresponding to a first power output when the actuation rate is lower than an actuation rate threshold and a second power output when the actuation rate is higher than the actuation rate threshold, the second power output being greater than the first power output;
determining that the actuation rate is higher than the actuation rate threshold; and responsive the determining and with the accelerator at the accelerator position, causing the electric vehicle to generate the second power output.

In another aspect, the disclosure describes a system for operating an electric vehicle. The system comprises:
an accelerator actuatable by an operator of the electric vehicle to generate a propulsion command including an accelerator position and an actuation rate of the accelerator to the accelerator position; and
one or more controllers operatively connected to the accelerator and to a powertrain of the electric vehicle, the one or more controllers being configured to:
receive the propulsion command;
determine if the actuation rate is higher than an actuation rate threshold;
with the accelerator at the accelerator position, execute the propulsion command by:
when the actuation rate of the accelerator is lower than the actuation rate threshold, cause the powertrain of the electric vehicle to accelerate at a first acceleration; and
when the actuation rate of the accelerator is higher than the actuation rate threshold, cause the powertrain of the electric vehicle to accelerate at a second acceleration, the second acceleration being higher than the first acceleration.

In another aspect, the disclosure describes an electric vehicle comprising:
a powertrain including an electric motor for propelling the electric vehicle and a battery operatively connected to drive the electric motor;
an accelerator actuatable by an operator of the electric vehicle; and one or more controllers operatively connected to the powertrain and to the accelerator, the one or more controllers being configured to:
receive a propulsion command via the accelerator, the propulsion command being indicative of an accelerator position and an actuation rate of the accelerator to the accelerator position;
with the accelerator at the accelerator position, executing the propulsion command by:
when the actuation rate of the accelerator is lower than an actuation rate threshold, command the powertrain of the electric vehicle to accelerate at a first acceleration; and
when the actuation rate of the accelerator is higher than the actuation rate threshold, command the powertrain of the electric vehicle to accelerate at a second acceleration, the second acceleration being higher than the first acceleration.

Further details of these and other aspects of the subject matter of this application will be apparent from the detailed description included below and the drawings.

### DESCRIPTION OF THE DRAWINGS

Reference is now made to the accompanying drawings, in which:

FIGS. 1A and 1B are a perspective view and a longitudinal cross-sectional view respectively of an exemplary watercraft including a system as described herein;

FIG. 2A is a side elevation view of an exemplary snowmobile including a system as described herein;

FIG. 2B is a partial schematic side elevation view of the snowmobile of FIG. 2A with body panels and other components removed to show internal components of the snowmobile of FIG. 2A;

FIG. 2C is a perspective view of a mid-bay of the snowmobile of FIG. 2A;

FIG. 3 is a schematic illustration of the watercraft of FIGS. 1A and 1B including a system for operating the watercraft based on an accelerator actuation rate;

FIG. 4 is a table listing operating parameters defining three exemplary operating modes for the watercraft;

FIG. 5 is a graph showing exemplary relationships between operating speed, torque output and power output from the electric motor of the watercraft associated with the operating modes of FIG. 4;

FIGS. 6A-6C are flow diagrams illustrating exemplary methods of operating an electric vehicle based on an accelerator actuation rate;

FIG. 7 is a perspective view of an exemplary accelerator disposed on a right-hand portion of the handlebar of the watercraft;

FIG. 8 is a graph showing an exemplary relationship of a power output from a powertrain of the watercraft or an operating speed of a motor of the powertrain as a function of the position of the accelerator;

FIG. 9 is a table listing modified operating parameters defining temporary power increases for different operating modes of the watercraft as a function of an accelerator actuation rate;

FIGS. 10A and 10B are graphs showing exemplary relationships of scaling factors use to modify a motor acceleration limit and a local power output limit respectively as a function of the accelerator actuation rate; and

FIG. 11 is a graph showing three exemplary relationships of a motor operating speed versus time associated with three different respective accelerator actuation rates.

### DETAILED DESCRIPTION

The present disclosure relates to methods and systems for operating an electric (e.g., powersport) vehicle based on a rate at which an accelerator of the vehicle is actuated by the operator. How fast the operator actuates the accelerator can be used to indicate the acceleration responsiveness desired by the operator. In some embodiments, the electric vehicle may be accelerated at a rate that depends on the rate at which the accelerator is actuated.

In some embodiments, the use of a higher accelerator actuation rate may cause a powertrain of the vehicle to temporarily generate a power output greater than a power output limit imposed by a currently-active (e.g., power-saving or normal) operating mode to accelerate the vehicle while remaining in the currently-active operating mode. For example, the use of a higher accelerator actuation rate may be used to temporarily increase the responsiveness of the vehicle without having to switch to a less restrictive (i.e., high-performance) operating mode. For example, a higher power output may be commanded to seamlessly mitigate a transient situation of the vehicle while remaining in the current operating mode. The ability to command a higher power output to mitigate a transient situation while remaining in a current (e.g., restrictive) operating mode may encourage operators to use and stay in the restrictive operating mode to promote reduced battery consumption and longer range for the vehicle.

Powersport vehicles including off-road vehicles such as snowmobiles, all-terrain vehicles (ATVs) and utility terrain vehicles (UTVs) can be operated in a variety of conditions (e.g., terrains). In some situations, an operator (driver) of the vehicle may want to temporarily access an increase in power output to traverse challenging (e.g., steep, soft) terrain and/or to avoid getting stuck in deep snow for example. In some embodiments, the methods and systems described herein may facilitate the delivery of a relatively seamless increase in power output without requiring a change in operating mode and without interrupting the operation of the vehicle.

In case of a (e.g., personal) watercraft, the temporary increase in power output in response to the higher accelerator actuation rate may be used to more quickly accelerate the watercraft and reach a planing state while remaining in a current (e.g., restrictive) operating mode. Achieving the planing state or getting “on plane” refers to the watercraft having sufficient velocity so that the weight of the watercraft is mainly supported by hydrodynamic lift, as opposed to being mainly supported by hydrostatic lift (buoyancy). Operating the watercraft in the planing state may be relatively energy efficient and the ability to reach the planing state more quickly while remaining in the restrictive operating mode may improve the user experience while promoting energy efficiency and extended range.

In case of a snowmobile, the temporary increase in power output may permit the mitigation of a transient condition where the track of the snowmobile is getting stuck in snow. For example, the temporary increase in power output may permit an electric snowmobile to build up track speed and break free of the snow while remaining in the current (e.g., power-saving or normal) operating mode.

The term “connected” may include both direct connection in which two elements that are connected to each other contact each other, and indirect connection in which at least one additional element is located between the two elements. The term “substantially” as used herein may be applied to modify any quantitative representation which could permissibly vary without resulting in a change in the basic function to which it is related. Aspects of various embodiments are described through reference to the drawings.

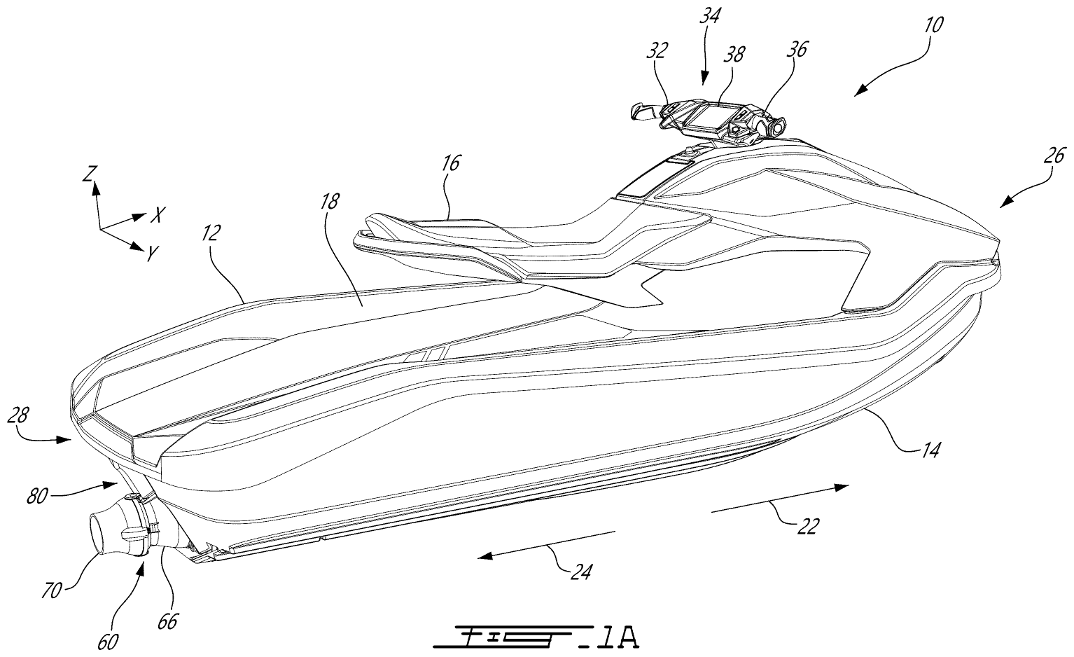

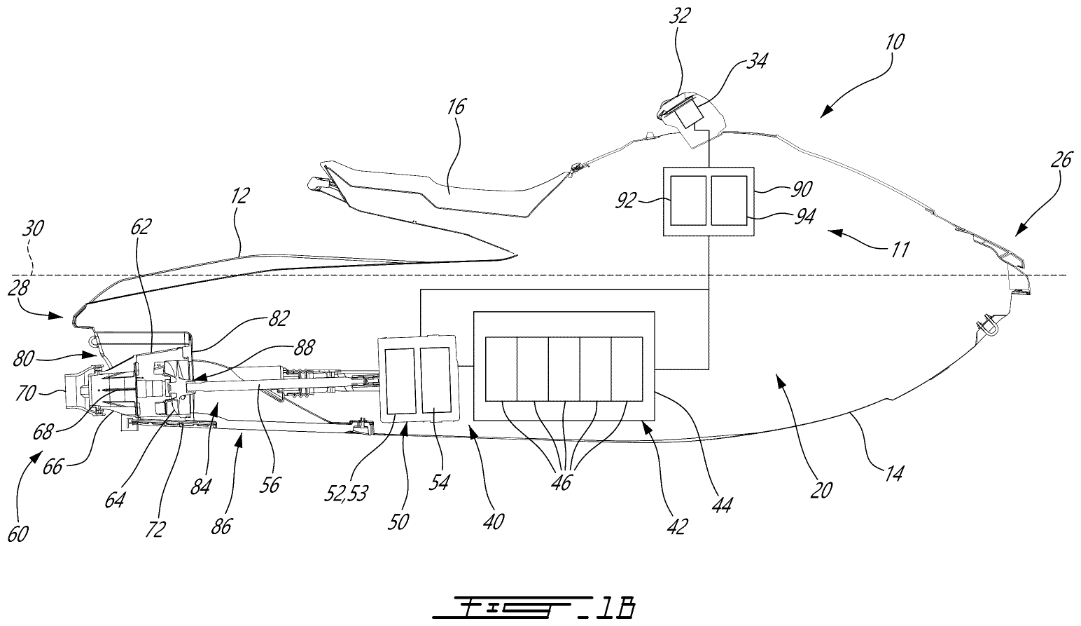

FIGS. 1A and 1B illustrate a perspective view and a longitudinal cross-section view of a watercraft 10, according to an embodiment. The watercraft 10 may be utilized for transporting one or more riders (e.g., an operator and optionally one or more passengers) over a body of water. The watercraft 10 may also be referred to as a “personal watercraft” or “PWC”. Watercraft 10 may include system 11, described further below, for operating watercraft 10.

An upper portion of the watercraft 10 is formed of a deck 12 and a lower portion of the watercraft 10 is formed of a hull 14, which sits in the water. A straddle seat 16 is secured to the deck 12 and sized for accommodating the riders of the watercraft 10. The deck 12 defines foot wells 18 on either side of the straddle seat 16. A steering mechanism 32 (e.g., a set of handlebars) is coupled to the deck 12 forward of the straddle seat 16. The steering mechanism 32 is rotatable by an operator of the watercraft 10 to steer the watercraft 10. The hull 14 and the deck 12 may be coupled together along a seam using adhesives and/or fasteners. When coupled together, the hull 14 and the deck 12 enclose an interior volume 20 of the watercraft 10 which provides buoyancy to the watercraft 10 and houses at least some components thereof.

The watercraft 10 may move along a forward direction of travel 22 and a rear or aft direction of travel 24 (shown in FIG. 1A). The forward direction of travel 22 is the direction along which the watercraft 10 travels in most instances when displacing. The aft direction of travel 24 is the direction along which the watercraft 10 displaces occasionally, such as when reversing. The watercraft 10 includes a bow 26 and a stern 28 defined with respect to the forward direction of travel 22 and the aft direction of travel 24, such that the bow 26 is positioned ahead of the stern 28 relative to the forward direction of travel 22, and that the stern 28 is positioned astern of the bow 26 relative to the aft direction of travel 24. The watercraft 10 defines a longitudinal center axis 30 (shown in FIG. 1B) that extends between the bow 26 and the stern 28. A port side and a starboard side of the watercraft 10 are defined on opposite lateral sides of the center axis 30. The positional descriptors “front”, “aft”, “rear” and terms related thereto are used in the present disclosure to describe the relative position of components of the watercraft 10. For example, if a first component of the watercraft 10 is described herein as being in front of, or forward of, a second component, then the first component is closer to the bow 26 than the second component. Similarly, if a first component of the watercraft 10 is described herein as being aft of, or rearward of, a second component, then the first component is closer to the stern 28 than the second component. The watercraft 10 also includes a three-axes frame of reference that is displaceable with the watercraft 10, where the Z-axis is parallel to the vertical direction and defines heave and yaw (via rotation about the Z-axis) of the watercraft 10, the X-axis is parallel to the center axis 30 and defines surge and roll (via rotation about the X-axis) of the watercraft 10, and the Y-axis is perpendicular to both the X and Z-axes (extending laterally between the starboard and port sides) and defines sway and pitch (via rotation about the Y-axis) of the watercraft 10.

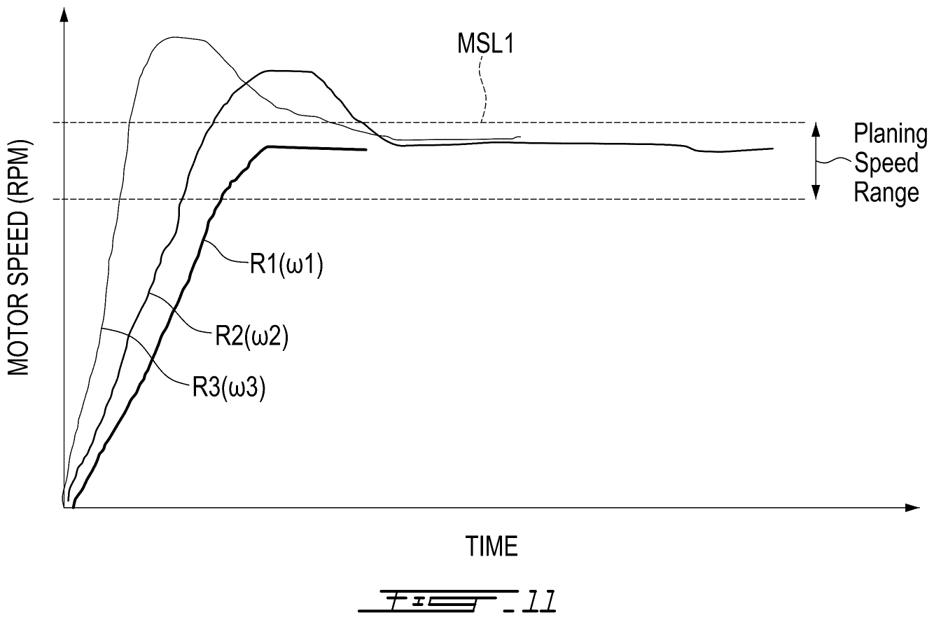

Referring to FIG. 11B, the watercraft 10 is electrically propelled by an electric powertrain 40. The electric powertrain 40 includes an electric battery 42 (also referred to as a “battery pack”), and an electric motor 50. The powertrain 40 is operatively connected to a driveshaft 56 and a jet propulsion system 60. The electric battery 42, motor 50 and driveshaft 56 may be located, in whole or in part, within the interior volume 20 of the watercraft 10. The interior volume 20 may also include other components suitable for use with the watercraft 10 such as storage compartments, a thermal management system, floatation foam and/or a charger, for example.

The battery 42 includes a battery enclosure 44 housing one or more battery modules 46. In the illustrated example, the battery modules 46 are arranged in a row and/or stacked within the battery enclosure 44. The battery enclosure 44 may support the battery modules 46 and protect the battery modules 46 from external impacts, water and/or other hazards or debris. Each battery module 46 may contain one or more battery cells, such as pouch cells, cylindrical cells and/or prismatic cells, for example. In some implementations, the battery cells are rechargeable lithium-ion battery cells. The battery 42 may also include other components to help facilitate and/or improve the operation of the battery 42, including temperature sensors to monitor the temperature of the battery cells, voltage sensors to measure the voltage of one or more battery cells, current sensors to implement coulomb counting to infer the state of charge (SOC) of the battery 42, and/or thermal channels that circulate a thermal fluid to control the temperature of the battery cells, for example. In some implementations, the battery 42 may output electric power at a voltage between 300 and 800 volts, for example. The watercraft 10 may also include a charger (not shown) to convert alternating current (AC) power from an external power source to direct current (DC) power to charge the battery 42. The charger may include, or be connected to, a charging port positioned forward of the straddle seat 16 to connect to a charging cable from an external power source. In some implementations, the charging port is covered by one or more protective flaps (e.g., made of plastic and/or rubber) to protect the charging port from water and other debris.

It should be noted that the battery 42 illustrated in FIG. 1B is shown by way of example. Other shapes, sizes and configurations of the battery 42 are contemplated. For example, while the battery 42 is shown forward of the motor 50 and driveshaft 56 in FIG. 1B, this need not always be the case. At least a portion of the battery 42 may also, or instead, extend overtop of the motor 50 and/or the driveshaft 56. Further, at least a portion of the battery 42 may be positioned on the port and starboard sides of the motor 50 and/or the driveshaft 56. In some implementations, the battery 42 may include multiple batteries that are interconnected via electrical cables, and housed in one or more battery enclosures 44.

The motor 50 may convert the electric power output from the battery 42 into motive power to drive the jet propulsion system 60 of the watercraft 10. In the illustrated embodiment, the motor 50 is a permanent magnet synchronous motor having a rotor 52 and stator 53. The motor 50 also includes a power electronics module 54 (sometimes referred to as an inverter) to convert the DC power from the battery 42 to AC power having a desired voltage, current and waveform to drive the motor 50. In some implementations, the power electronics module 54 may include one or more capacitors to reduce the voltage variations between the high and low DC voltage leads, and one or more electric switches (e.g., insulated-gate bipolar transistors (IGBTs)) to generate the AC power. In some implementations, the motor 50 has a maximum output power of between 90 kW and 135 kW, for example. In other implementations, the motor 50 has a maximum output power greater than 135 kW.

In some implementations, the motor 50 may include sensors configured to sense one or more parameters of the motor 50. The sensors may be implemented in the rotor 52, the stator 53 and/or the power electronics module 54. The sensors may include a position sensor (e.g., an encoder) to measure a position and/or rotational speed of the rotor 52, and/or a speed sensor (e.g., a revolution counter) to measure the rotational speed of the rotor 52. Alternatively or additionally, the sensors may include a torque sensor to measure an output torque from the motor 50 and/or a current sensor (e.g., a Hall effect sensor) to measure an output current from the power electronics module 54.

Other embodiments of the motor 50 are also contemplated. For example, the power electronics module 54 may be integrated into the housing or casing of motor 50, as shown in FIG. 1B. However, the power electronics module 54 may also, or instead, be provided externally to the housing or casing of the motor 50. In some embodiments, the motor 50 may be a type other than a permanent magnet synchronous motor. For example, the motor 50 may instead be a brushless direct current motor.

The jet propulsion system 60 (also referred to as a “jet pump”) of the watercraft 10 creates a pressurized jet of water which provides thrust to propel the watercraft 10 through the water. A tunnel 80 formed at the stern 28 of the hull 14 at least partially accommodates the jet propulsion system 60. The jet propulsion system 60 includes a housing 62, which is a hollow body that delimits an interior channel or duct of the jet propulsion system 60. The housing 62 is coupled to the hull 14 at a rear wall 82 formed at a front end of the tunnel 80. The hull 14 also at least partially defines a water intake duct 84 having an inlet 86 provided at an underside of the hull 14 and an outlet 88 at the rear wall 82 to provide water to the jet propulsion system 60. In some implementations, a grate may be disposed over the inlet 86 to inhibit the intake of debris into the jet propulsion system 60.

The jet propulsion system 60 includes an impeller 64 positioned within the housing 62 to draw water through the intake duct 84. An inner wall of the housing 62 that surrounds the impeller 64 (referred to as a “wear ring”) may be a component that experiences wear and may be replaced. The impeller 64 is coupled to the motor 50 via the driveshaft 56. The driveshaft 56 extends through the hull 14, the intake duct 84 and the outlet 88 to couple to the impeller 64. The driveshaft 56 transfers motive power from the motor 50 to the impeller 64. The motor 50 is therefore drivingly engaged to the impeller 64. In the illustrated embodiment, the motor 50 is in a direct-drive arrangement with the impeller 64, such that a connection between the motor 50 and the impeller 64 is free of a gearbox. In other embodiments, a transmission may be used to provide a speed ratio between the motor 50 and the impeller 64.

Water ejected from the impeller 64 is directed through a venturi 66 (also referred to as a “nozzle”) formed by the housing 62 that further accelerates the water to provide additional thrust. The venturi 66 includes inwardly extending stator vanes 68 to convert the rotational flow of the water exiting the impeller 64 to thrust. The accelerated water jet is ejected from the venturi 66 via a pivoting steering nozzle 70 to provide a directionally controlled jet of water. The steering mechanism 32 may be mechanically coupled to the steering nozzle 70 to allow an operator to pivot the steering nozzle 70 and steer the watercraft 10. Pivoting the steering nozzle 70 horizontally to direct the water jet towards the port or starboard side of the watercraft 10 may turn the watercraft 10 to either side. The steering nozzle 70 may also pivot vertically to control the trim of the steering nozzle 70, thereby adjusting the running angle of the watercraft 10 in the water. Trimming the steering nozzle 70 upward helps to push the bow 26 of the watercraft 10 upward and may allow for the watercraft 10 to travel faster. Conversely, trimming the steering nozzle 70 downward helps to push the bow 26 of the watercraft 10 into the water which may allow for better navigation of the watercraft 10.

The watercraft 10 further includes a ride plate 72 that is coupled to the hull 14 below the jet propulsion system 60. The ride plate 72 may partially define the intake duct 84 and include a bottom surface that contributes to the ride and handling characteristics of the watercraft 10 in the water. In some implementations, the ride plate 72 may also include a heat exchanger forming part of a thermal management system of the watercraft 10. The heat exchanger may be a closed-loop heat exchanger having channels formed therein to carry a thermal fluid. The thermal fluid in the heat exchanger may be cooled by the water flowing past the ride plate 72, and then be pumped through thermal channels in the battery 42 and the motor 50, for example, to regulate the heat of those components during use. In some embodiments, the thermal management system may also include a heater (not shown) to heat the thermal fluid to provide heating to one or both of the battery 42 and the motor 50.

One or more controllers 90 (referred to hereinafter in the singular) and an instrument panel 34 are part of a control system for controlling operation of the watercraft 10. The instrument panel 34 allows an operator of the watercraft 10 to generate user inputs or instructions for the watercraft 10. The controller 90 is connected to the instrument panel 34 to receive the instructions therefrom and perform operations to implement those instructions. In the illustrated embodiment, the instrument panel 34 is provided on the steering mechanism 32 and the controller 90 is disposed within the interior volume 20, but this need not always be the case.

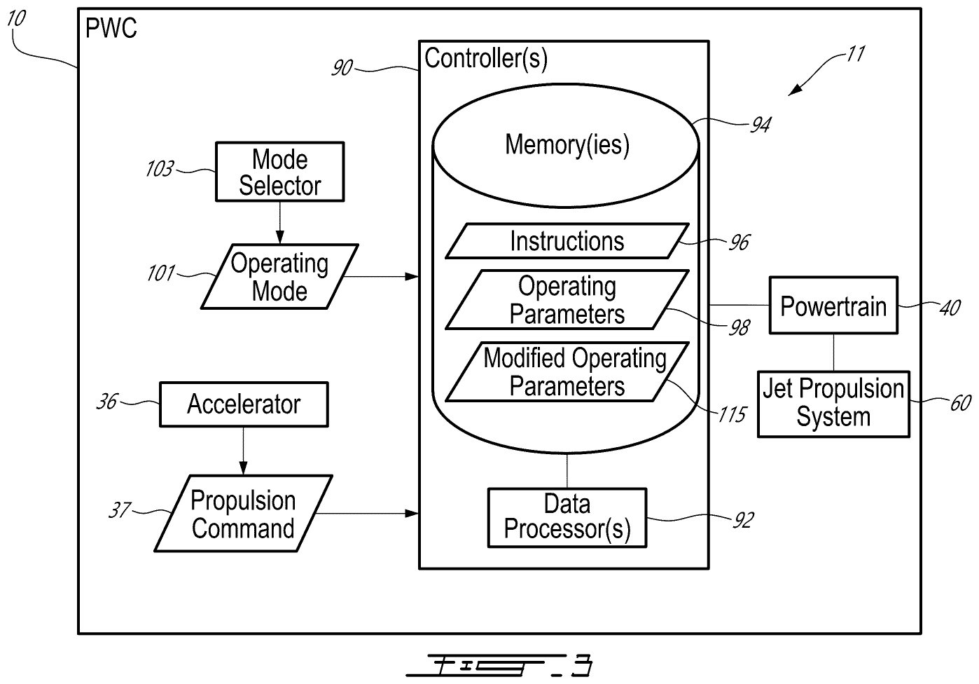

The instrument panel 34 includes an accelerator 36 (also referred to as a “throttle”) to allow an operator to control the thrust generated by the powertrain 40. For example, the accelerator 36 may include a lever to allow the operator to selectively generate an accelerator signal such as propulsion command 37 shown in FIG. 3. The controller 90 is operatively connected to the accelerator 36 and to the motor 50 to receive the propulsion command 37 and produce a corresponding output from the motor 50. In some implementations, the propulsion command 37 is mapped to a rotational speed (e.g., revolutions per minute (RPM)) of the motor 50. When the controller 90 receives propulsion command 37 from the accelerator 36, the controller 90 may map propulsion command 37 to a rotational speed of the motor 50 and control the power electronics module 54 to produce that rotational speed using feedback from sensors in the motor 50. The mapping of propulsion command 37 to an output from the motor 50 may be based on an operating mode (also know as “performance mode”) of the watercraft 10 (e.g., whether the watercraft 10 is in a power-saving operating mode, a normal operating mode or a high-performance operating mode). In some examples, the mapping of propulsion command 37 to an output from the motor 50 may be based on current operating conditions of the powertrain 40 (e.g., a temperature of the battery 42 and/or motor 50, a SOC of the battery 42, etc.). In still other examples, the mapping of propulsion command 37 to an output from the motor 50 may be user-configurable, such that a user may customize an accelerator position to motor output mapping.

The watercraft 10 may be capable of generating reverse thrust to slow down the watercraft 10 when traveling in the forward direction of travel 22 and/or to propel the watercraft 10 in the reverse direction of travel 24. The instrument panel 34 may include a distinct user input device (e.g., a brake lever and/or reverse button) to instruct the controller 90 to generate reverse thrust. In some implementations, reverse thrust is generated by reversing the direction of the motor 50, which draws water in from the steering nozzle 70 and expels the water out from the inlet 86 of the intake duct 84. Alternatively, reverse thrust may be generated using a reverse bucket or deflector gate that deflects the water jet from the venturi 66 forwards, thereby generating reverse thrust.

In addition to the accelerator 36, the instrument panel 34 may include other user input devices (e.g., levers, buttons and/or switches) to control various other functionality of the watercraft 10. These user input devices may be connected to the controller 90, which executes the instructions received from the user input devices. Non-limiting examples of such user input devices include a device to switch the watercraft 10 between different vehicle states (e.g., “off”, “neutral” and “drive” states), a device (e.g., mode selector 103 shown in FIG. 3) to switch the watercraft 10 between different operating modes, and a device to adjust the trim of the steering nozzle 70. The instrument panel 34 also includes a display screen 38 (shown in FIG. 1A) connected to the controller 90 that displays information pertaining to the watercraft 10 to an operator. Non-limiting examples of such information include the current state of the watercraft 10, the current operating mode of the watercraft 10, the speed of the watercraft 10, the SOC of the battery 42, the RPM of the motor 50, and the power output from the motor 50. The display screen 38 may include a liquid crystal display (LCD) screen, thin-film-transistor (TFT) LCD screen, light-emitting diode (LED) or other suitable display device. In some embodiments, display screen 38 may be touch-sensitive to facilitate operator inputs.

The controller 90 may also control additional functionality of the watercraft 10. For example, the controller 90 may control a battery management system (BMS) to monitor the SOC of the battery 42 and manage charging and discharging of the battery 42. In another example, the controller 90 may control a thermal management system to manage a temperature of the battery 42 and/or the motor 50 using a thermal fluid cooled by a heat exchanger in the ride plate 72. Temperature sensors in the battery 42 and/or the motor 50 may be connected to the controller 90 to monitor the temperature of these components.

The controller 90 includes one or more data processors 92 (referred hereinafter as “processor 92”) and non-transitory machine-readable memory 94. The memory 94 may store machine-readable instructions which, when executed by the processor 92, cause the processor 92 to perform any computer-implemented method or process described herein. The processor 92 may include, for example, any type of general-purpose microprocessor or microcontroller, a digital signal processing (DSP) processor, an integrated circuit, an application-specific integrated circuit (ASIC), a field programmable gate array (FPGA), a reconfigurable processor, other suitably programmed or programmable logic circuits, or any combination thereof. The memory 94 may include any suitable machine-readable storage medium such as, for example, an electronic, magnetic, optical, electromagnetic, infrared, or semiconductor system, apparatus, or device, or any suitable combination thereof. The memory 94 may be located internally and/or externally to the controller 90.

Although the controller 90 is shown as a single component in FIG. 1B, this is only an example. In some implementations, the controller 90 may include multiple controllers distributed at various locations in the watercraft 10. For example, the controller 90 may include a vehicle control unit (also referred to as a “body controller”) that is responsible for interpreting the inputs from various other controllers in the watercraft 10. Non-limiting examples of these other controllers include a motor controller that is part of the power electronics module 54 and a battery management controller that is part of the battery 42. Optionally, separate battery management controllers may be implemented in the each of the battery modules 46 to form a distributed battery management system.

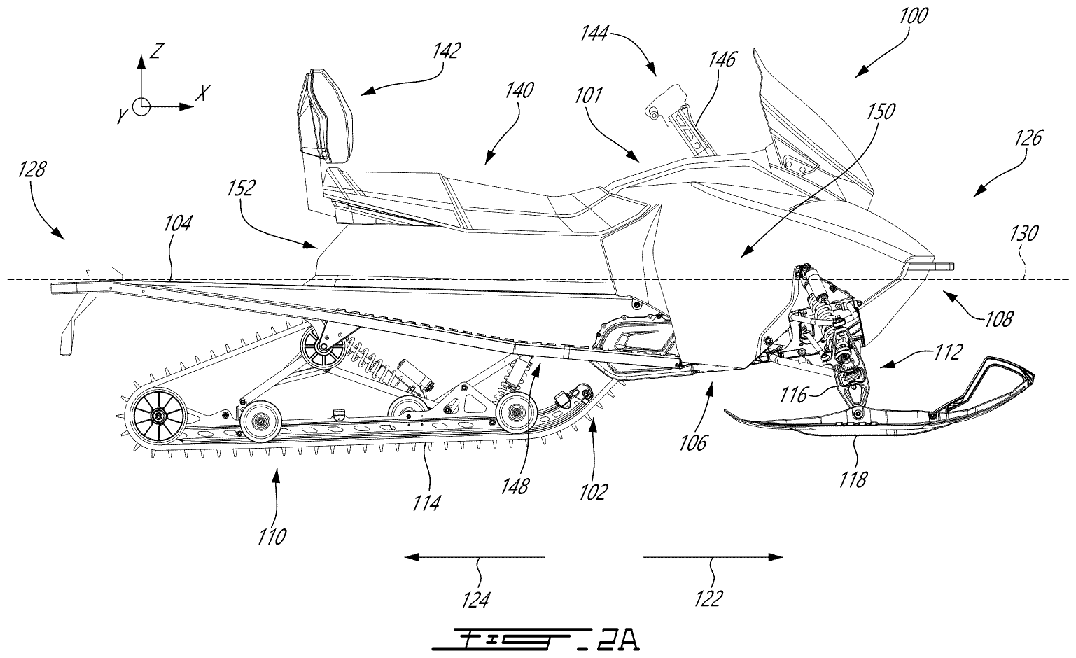

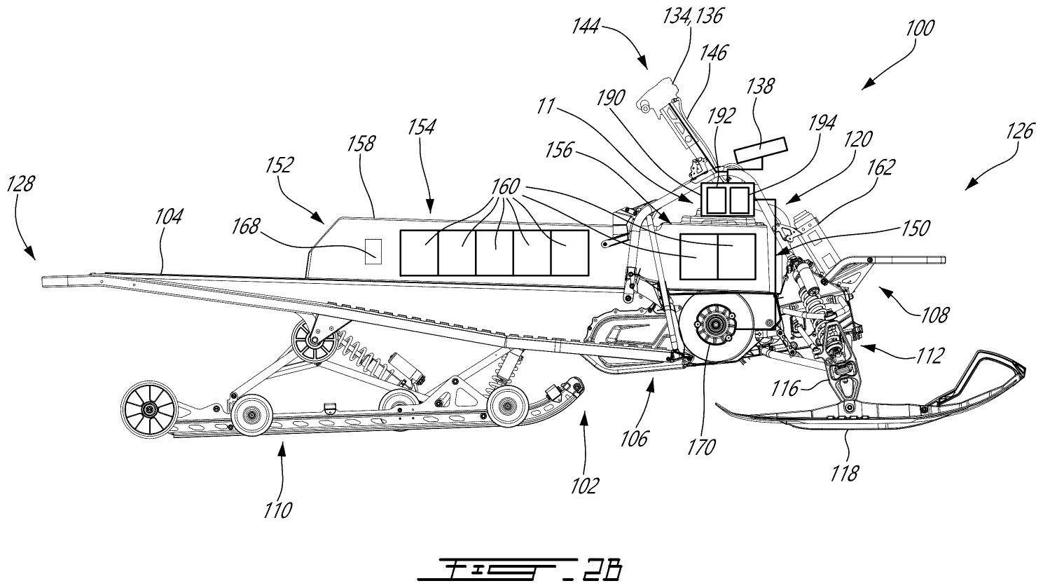

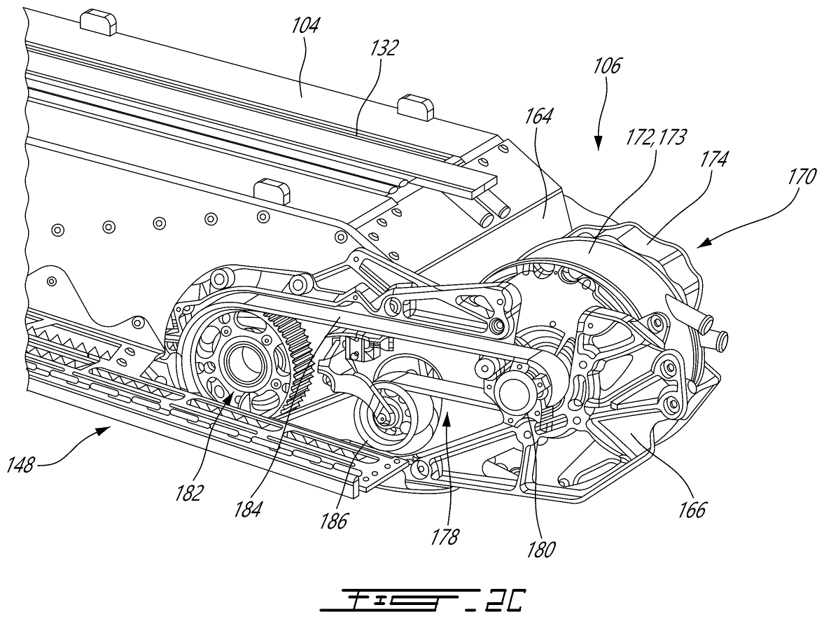

FIG. 2A illustrates a side plan view of a snowmobile 100, according to an embodiment, and FIG. 2B illustrates another side plan view of the snowmobile 100 with several body panels and other components removed so that the interior of the snowmobile 100 may be viewed. Snowmobile 100 may include system 11, described further below, for operating snowmobile 100.

The snowmobile 100 includes a frame 102, which may also be referred to as a “chassis” or “body”, that provides a load bearing framework for the snowmobile 100. In the illustrated embodiment, the frame 102 includes a longitudinal tunnel 104, a mid-bay 106 (or “bulkhead”) coupled forward of the tunnel 104, and a front sub-frame 108 (or “front brace”) coupled forward of the mid-bay 106. In some implementations, the mid-bay 106 may form part of the front sub-frame 108.

The snowmobile 100 also includes a rear suspension assembly 110 and a front suspension assembly 112 to provide shock absorption and improve ride quality. The rear suspension assembly 110 may be coupled to the underside of the tunnel 104 to facilitate the transfer of loads between the rear suspension assembly 110 and the tunnel 104. The rear suspension assembly 110 supports a drive track 114 having the form of an endless belt for engaging the ground (e.g., snow) and propelling the snowmobile 100. The rear suspension assembly may include, inter alia, one or more rails and/or idler wheels for engaging with the drive track 114, and one or more control arms and damping elements (e.g., elastic elements such as coil and/or torsion springs forming a shock absorber) connecting the rails to the tunnel 104. The front suspension assembly 112 includes two suspension legs 116 coupled to the front sub-frame 108 and to respective ground engaging front skis 118 (only one suspension leg 116 and ski 118 are visible in FIGS. 1A and 1B). Each of the suspension legs 116 may include two A-frame arms connected to the front sub-frame 108, a damping element (e.g., an elastic element) connected to the front sub-frame 108, and a spindle connecting the A-frame arms and the damping element to a respective one of the skis 118. The suspension legs 116 transfer loads between the skis 118 and the front sub-frame 108. In the illustrated embodiment, the frame 102 also includes an over structure 120 (shown in FIG. 1B), that may include multiple members (e.g., tubular members) interconnecting the tunnel 104, the mid-bay 106 and/or the front sub-frame 108 to provide additional rigidity to the frame 102. However, as discussed elsewhere herein, the over structure 120 may be omitted in some embodiments.

The snowmobile 100 may move along a forward direction of travel 122 and a rearward direction of travel 124 (shown in FIG. 2A). The forward direction of travel 122 is the direction along which the snowmobile 100 travels in most instances when displacing. The rearward direction of travel 124 is the direction along which the snowmobile 100 displaces only occasionally, such as when it is reversing. The snowmobile 100 includes a front end 126 and a rear end 128 defined with respect to the forward direction of travel 122 and the rearward direction of travel 124. For example, the front end 126 is positioned ahead of the rear end 128 relative to the forward direction of travel 122. The snowmobile 100 defines a longitudinal center axis 130 that extends between the front end 126 and the rear end 128. Two opposing lateral sides of the snowmobile 100 are defined parallel to the center axis 130. The positional descriptors “front”, “rear” and terms related thereto are used in the present disclosure to describe the relative position of components of the snowmobile 100. For example, if a first component of the snowmobile 100 is described herein as being in front of, or forward of, a second component, then the first component is closer to the front end 126 than the second component. Similarly, if a first component of the snowmobile 100 is described herein as being behind, or rearward of, a second component, then the first component is closer to the rear end 128 than the second component. The snowmobile 100 also includes a three-axes frame of reference that is displaceable with the snowmobile 100, where the Z-axis is parallel to the vertical direction, the X-axis is parallel to the center axis 130, and the Y-axis is parallel to the lateral direction.

The snowmobile 100 is configured to carry one or more riders, including a driver (sometimes referred to as an “operator”) and optionally one or more passengers. In the illustrated example, the snowmobile 100 includes a straddle seat 140 to support the riders. Optionally, the straddle seat 140 includes a backrest 142. The operator of the snowmobile 100 may steer the snowmobile 100 using a steering mechanism 144 (e.g., handlebars), which are operatively connected to the skis 118 via a steering shaft 146 to control the direction of the skis 118. The tunnel 104 may also include or be coupled to footrests 148 (also referred to as “running boards”), namely left and right footrests each sized for receiving a foot of one or more riders sitting on the straddle seat 140.

Referring to FIG. 2B, the snowmobile 100 is electrically propelled by an electric powertrain 150. The powertrain 150 includes an electric battery 152 (also referred to as a “battery pack”) and an electric motor 170. The battery 152 is electrically connected to the motor 170 to provide electric power to the motor 170. The motor 170, in turn, is drivingly coupled to the drive track 114 to propel the snowmobile 100 across the ground.

The battery 152 may include a battery enclosure 158 that houses one or more battery modules 160. The battery enclosure 158 may support the battery modules 160 and protect the battery modules 160 from external impacts, water and/or other hazards or debris. Each battery module 160 may contain one or more battery cells, such as pouch cells, cylindrical cells and/or prismatic cells, for example. In some implementations, the battery cells are rechargeable lithium-ion battery cells. The battery 152 may also include other components to help facilitate and/or improve the operation of the battery 152, including temperature sensors to monitor the temperature of the battery cells, voltage sensors to measure the voltage of one or more battery cells, current sensors to implement coulomb counting to infer the state of charge (SOC) of the battery 42, and/or thermal channels that circulate a thermal fluid to control the temperature of the battery cells. In some implementations, the battery 152 may output electric power at a voltage of between 300 and 800 volts, for example. The snowmobile 100 may also include a charger 162 to convert AC to DC current from an external power source to charge the battery 152. The charger 162 may include, or be connected to, a charging port positioned forward of the straddle seat 140 to connect to a charging cable from an external power source. In some implementations, the charging port is covered by one or more protective flaps (e.g., made of plastic and/or rubber) to protect the charging port from water, snow and other debris.

In some implementations, the battery 152 may be generally divided into a tunnel battery portion 154 and a mid-bay battery portion 156. The tunnel battery portion 154 may be positioned above and coupled to the tunnel 104. As illustrated, the straddle seat 140 is positioned above the tunnel battery portion 154 and, optionally, the straddle seat 140 may be supported by the battery enclosure 158 and/or internal structures within the battery 152. The mid-bay battery portion 156 extends into the mid-bay 106 and may be coupled to the mid-bay 106 and/or to the front sub-frame 108. The tunnel battery portion 154 and the mid-bay battery portion 156 may share a single battery enclosure 158, or alternatively separate battery enclosures. In the illustrated example, the tunnel battery portion 154 and the mid-bay battery portion 156 each include multiple battery modules 160 that are arranged in a row and/or stacked within the battery enclosure 158.

It should be noted that other shapes, sizes and configurations of the battery 152 are contemplated. For example, the battery 152 may include multiple batteries that are interconnected via electrical cables. In some embodiments, the battery enclosure 158 may be a structural component of the snowmobile 100 and may form part of the frame 102. For example, the battery enclosure 158 may be coupled to the front sub-frame 108 to transfer loads between the front sub-frame 108 and the tunnel 104. The battery enclosure 158 may be formed from a fiber composite material (e.g., a carbon fiber composite) for additional rigidity. Optionally, in the case that the battery enclosure 158 is a structural component of the snowmobile 100, the over structure 120 may be omitted.

FIG. 2C is a perspective view of the mid-bay 106 of the snowmobile 100. As illustrated, the motor 170 is disposed in a lower portion of the mid-bay 106, below the mid-bay battery portion 156 and forward of a wall 164 defining a front end of the tunnel 104. The motor 170 may be mounted to a transmission plate 166 that is supported between the tunnel 104 and the front sub-frame 108 to help support the motor 170 within the mid-bay 106.

In the illustrated embodiment, the motor 170 is a permanent magnet synchronous motor having a rotor 172 and stator 173. The motor 170 also includes power electronics module 174 (sometimes referred to as an inverter) to convert the direct current (DC) power from the battery 152 to alternating current (AC) power having a desired voltage, current and waveform to drive the motor 170. In some implementations, the power electronics module 174 may include one or more capacitors to reduce the voltage variations between the high and low DC voltage leads, and one or more electric switches (e.g., insulated-gate bipolar transistors (IGBTs)) to generate the AC power. In some implementations, the motor 170 has a maximum output power of between 90 kW and 135 kW. In other implementations, the motor 170 has a maximum output power greater than 135 kW.

In some implementations, the motor 170 may include sensors configured to sense one or more parameters of the motor 170. The sensors may be implemented in the rotor 172, the stator 173 and/or the power electronics module 174. The sensors may include a position sensor (e.g., an encoder) to measure a position and/or rotational speed of the rotor 172, and/or a speed sensor (e.g., a revolution counter) to measure the rotational speed of the rotor 172. Alternatively or additionally, the sensors may include a torque sensor to measure an output torque from the motor 170 and/or a current sensor (e.g., a Hall effect sensor) to measure an output current from the power electronics module 174.

Other embodiments of the motor 170 are also contemplated. For example, the power electronics module 174 may be integrated into the housing or casing of motor 170, as shown in FIG. 2C. However, the power electronics module 174 may also, or instead, be provided externally to the housing or casing of motor 170. In some embodiments, the motor 170 may be a type other than a permanent magnet synchronous motor. For example, the motor 170 may instead be a brushless direct current motor.

The motor 170 may convert the electric power output from the battery 152 into motive power that is transferred to the drive track 114 via a drive transmission 178. The drive transmission 178 engages with a motor drive shaft 180 of the motor 170. The motor drive shaft 180 may extend laterally through an opening in the transmission plate 166. The drive transmission 178 includes a track drive shaft 182 that extends laterally across the tunnel 104. The motor drive shaft 180 and the track drive shaft 182 may extend parallel to each other along transverse axes of the snowmobile 100 and may be spaced apart from each other along the longitudinal axis 130. In the illustrated embodiment, the motor drive shaft 180 is operably coupled to the track drive shaft 182 via a drive belt 184. Sprockets on the motor drive shaft 180 and the track drive shaft 182 may engage with lugs on the drive belt 184. A drive belt idler pulley 186 may also be implemented to maintain tension on the drive belt 184. In other embodiments, another form of linkage such as a drive chain, for example, may operatively connect the motor drive shaft 180 and the track drive shaft 182.

In operation, torque from the motor 170 is transferred from the motor drive shaft 180 to the track drive shaft 182 via the drive belt 184. The track drive shaft 182 includes one or more sprockets (not shown) that engage with lugs on the drive track 114, thereby allowing the track drive shaft 182 to transfer motive power to the drive track 114. It will be understood that the motor 170 may be operated in two directions (i.e., rotate clockwise or counter-clockwise), allowing the snowmobile 100 to travel in the forward direction of travel 122 and in the rearward direction of travel 124. In some implementations, the drive track 114 and the snowmobile 100 may be slowed down via electrical braking (e.g., regenerative braking) implemented by the motor 170 and/or by a mechanical brake (e.g., a disc brake) connected to one of the track drive shaft 182 or the motor drive shaft 180.

The snowmobile 100 may include a heat exchanger 132 that is coupled to, or integrated with, the tunnel 104. The heat exchanger 132 may form part of a thermal management system to control the temperature of the battery 152, the motor 170 and the charger 162, for example. The heat exchanger may include channels to carry a thermal fluid along a portion of the tunnel 104. During operation of the snowmobile 100, the heat exchanger 132 may be exposed to snow and cold air circulating in the tunnel 104 that cools the thermal fluid. The thermal fluid may then be pumped through thermal channels in the battery 152, the motor 170 and/or the charger 162, for example, to cool those components. In some implementations, the thermal management system of the snowmobile 100 may also include a heater 168 (shown in FIG. 2B) to heat the thermal fluid and warm the battery 152. Warming the battery 152 may be useful if the snowmobile 100 has been left for an extended period in a cold environment. In such a case, the temperature of the battery cells in the battery modules 160 may fall to a level where high power is limited from being drawn from the battery 152. Warming the battery 152 may bring the battery cells back into an efficient operating regime. In some implementations, the heater 168 is disposed within the battery enclosure 158.

Referring again to FIG. 2B, one or more controllers 190 (referred to hereinafter in the singular) and an instrument panel 134 are part of a control system for controlling operation of the snowmobile 100. The instrument panel 134 allows an operator of the snowmobile 100 to generate user inputs and/or instructions for the snowmobile 100. The controller 190 is connected to the instrument panel 134 to receive the instructions therefrom and perform operations to implement those instructions. In the illustrated embodiment, the instrument panel 134 is provided on the steering mechanism 144 and the controller 190 is disposed within the interior of the snowmobile 100, but this need not always be the case.

The instrument panel 134 includes an accelerator 136 (also referred to as a “throttle”) to allow an operator to control the power generated by the powertrain 150. For example, the accelerator 136 may include a lever to allow the operator to selectively generate an accelerator signal. The controller 190 is operatively connected to the accelerator 136 and to the motor 170 to receive the accelerator signal and produce a corresponding output from the motor 170. In some implementations, the accelerator signal is mapped to a torque of the motor 170. When the controller 190 receives an accelerator signal from the accelerator 136, the controller 190 maps the accelerator signal to a torque of the motor 170 and controls the power electronics module 174 to produce that torque using feedback from sensors in the motor 50. The mapping of the accelerator signal to an output from the motor 170 may be based on a performance mode of the snowmobile 100 (e.g., whether the snowmobile 100 is in a power-saving mode, a normal mode or a high-performance mode). In some examples, the mapping of the accelerator signal to an output from the motor 170 may be based on current operating conditions of the powertrain 150 (e.g., temperature of the battery 152 and/or motor 170, state of charge of the battery 152, etc.). In still other examples, the mapping of the accelerator signal to an output from the motor 170 may be user configurable, such that a user may customize an accelerator position to motor output mapping.

In addition to the accelerator 36, the instrument panel 34 may include other user input devices (e.g., levers, buttons and/or switches) to control various other functionality of the snowmobile 100. These user input devices may be connected to the controller 190, which executes the instructions received from the user input devices. Non-limiting examples of such user input devices include a brake lever to implement mechanical and/or electrical braking of the snowmobile 100, a reverse option to propel the snowmobile 100 in the rearward direction of travel 124, a device to switch the snowmobile 100 between different vehicle states (e.g., “off”, “neutral” and “drive” states), a device to switch the snowmobile 100 between different performance modes, a device to switch between regenerative braking modes (e.g. “off”, “low” and “high” modes) and a device to activate heating of handgrips of the steering mechanism. The snowmobile 100 also includes a display screen 138 connected to the controller 190. The display screen 138 may be provided forward of the steering mechanism 144, or in any other suitable location depending on the design of the snowmobile 100. The display screen 138 displays information pertaining to the snowmobile 100 to an operator. Non-limiting examples of such information include the current state of the snowmobile 100, the current performance mode of the snowmobile 100, the speed of the snowmobile 100, the state of charge (SOC) of the battery 152, the angular speed of the motor 170, and the power output from the motor 170. The display screen 138 may include a liquid crystal display (LCD) screen, thin-film-transistor (TFT) LCD screen, light-emitting diode (LED) or other suitable display device. In some embodiments, display screen 138 may be touch-sensitive to facilitate operator inputs.

The controller 190 may also control additional functionality of the snowmobile 100. For example, the controller 190 may control a battery management system (BMS) to monitor the SOC of the battery 152 and manage charging and discharging of the battery 152. In another example, the controller 190 may control a thermal management system to manage a temperature of the battery 152, the motor 170 and/or the charger 162 using a thermal fluid cooled by the heat exchanger 132 and/or heated by the heater 168. Temperature sensors in the battery 152 and/or the motor 170 may be connected to the controller 190 to monitor the temperature of these components.

The controller 190 includes one or more data processors 192 (referred hereinafter as “processor 192”) and non-transitory machine-readable memory 194. The memory 194 may store machine-readable instructions which, when executed by the processor 192, cause the processor 192 to perform any computer-implemented method or process described herein. The processor 192 may include, for example, any type of general-purpose microprocessor or microcontroller, a digital signal processing (DSP) processor, an integrated circuit, an application-specific integrated circuit (ASIC), a field programmable gate array (FPGA), a reconfigurable processor, other suitably programmed or programmable logic circuits, or any combination thereof. The memory 194 may include any suitable machine-readable storage medium such as, for example, an electronic, magnetic, optical, electromagnetic, infrared, or semiconductor system, apparatus, or device, or any suitable combination thereof. The memory 194 may be located internally and/or externally to the controller 190.

Although the controller 190 is shown as a single component in FIG. 2B, this is only an example. In some implementations, the controller 190 may include multiple controllers distributed at various locations in the snowmobile 100. For example, the controller 190 may include a vehicle control unit (also referred to as a “body controller”) that is responsible for interpreting the inputs from various other controllers in the snowmobile 100. Non-limiting examples of these other controllers include a motor controller that is part of the power electronics module 174 and a battery management controller that is part of the battery 152. Optionally, separate battery management controllers may be implemented in the each of the battery modules 160 to form a distributed battery management system.

Systems and methods are described below and shown in the present disclosure in relation to the watercraft 10, but the present disclosure may also be applied to other types of electric vehicles, including snowmobile 100, other types of electric off-road vehicles and electric powersport vehicles. Non-limiting examples of electric off-road/powersport vehicles include snowmobiles, motorcycles, watercraft such as boats and personal watercraft (PWC), all-terrain vehicles (ATVs), and utility task vehicles (UTVs) (e.g., side-by-side).

FIG. 3 is a schematic illustration of watercraft 10 including system 11 for operating watercraft 10 according to an actuation rate of accelerator 36. System 11 may be incorporated into snowmobile 100 where power train 40 may be operatively connected to drive track 114 instead of jet propulsion system 60. In some embodiments, system 11 may include one or more controllers 90 of watercraft 10. In some embodiments, system 11 may include a plurality of controllers 90 installed at various locations in watercraft 10 and the methods described herein may be performed using one or more controllers 90 operatively connected together. Aspects of the present disclosure may be embodied as systems, devices, methods and/or computer program products for controlling an operation of watercraft 10. For example, aspects of the present disclosure may take the form of a computer program product embodied in one or more non-transitory computer readable medium(ia) (e.g., memory 94) having computer readable program code (e.g., instructions 96) embodied thereon. The program code may be readable and executable by one or more computers (e.g., controller(s) 90), processor(s) or logic circuit(s) to perform a method described herein.

Controller 90 may include one or more data processors 92 (referred hereinafter in the singular) and non-transitory machine-readable memory 94. Memory 94 may store machine-readable instructions 96 which, when executed by processor 92, may cause processor 92 to perform one or more computer-implemented methods described herein.

Baseline operating parameters 98 may be stored in memory 94 or otherwise be available for use by controller 90. Baseline operating parameters 98 may define different operating modes 101 of watercraft 10 that may be selected by the operator via mode selector 103. Mode selector 103 may be part of instrument panel 34 and may include a push button, switch, dial or other suitable user input device(s) permitting the selection of operating mode 101. Watercraft 10 may have two or more different operating modes 101 available to the operator. Such operating modes 101 may be used to adjust performance characteristics of watercraft 10 according to the operator's skill or experience level, or according to the operator's preference(s). For example, watercraft 10 may be equipped with factory-defined operating modes 101 such as a power-saving operating mode which may be referred to as an “economy” or “extended range” mode, a normal operating mode which may be referred to as a “sport” mode, and a high-performance operating mode which may be referred to as a “wild” or “advanced” mode. The different operating modes 100 may be associated with different performance characteristic(s) exhibited by watercraft 10. Such operating modes may correspond to performance and/or operator skill levels such as novice, intermediate and expert respectively, and may be defined by factory-defined sets of baseline operating parameters 98 that are stored onboard (e.g., in memory 94 of controller 90) of watercraft 10. One or more operating modes 101 may be associated with the operating environment and/or operating conditions of watercraft 10. For example, some operating modes 101 may be associated with the payload carried by watercraft 10 and/or on the SOC of battery 42.

The power-saving operating mode may be a battery-saving operating mode intended to assist the operator in driving in a way that promotes reduced battery consumption and an extended range for watercraft 10. A high-performance operating mode may be intended to provide increased acceleration responsiveness and increased speed but with higher battery consumption and consequently a shorter range.

The normal operating mode may facilitate a vehicle operation between the power-saving operating mode and the high-performance operating mode. The normal operating mode may provide an acceleration responsiveness that is greater than the power-saving operating mode but that is lower than the high-performance operating mode. In other words, the normal operating mode may be considered a more restrictive operating mode compared to the high-performance operating mode and may define a lower power output limit from powertrain 40 and a lower acceleration of watercraft 10 compared to the high-performance operating mode. Similarly, the power-saving operating mode may be considered a more restrictive operating mode compared to the normal operating mode and the high-performance operating mode, and may define a lower power output limit from powertrain 40 and a lower acceleration of watercraft 10 compared to the normal operating mode and to the high-performance operating mode.

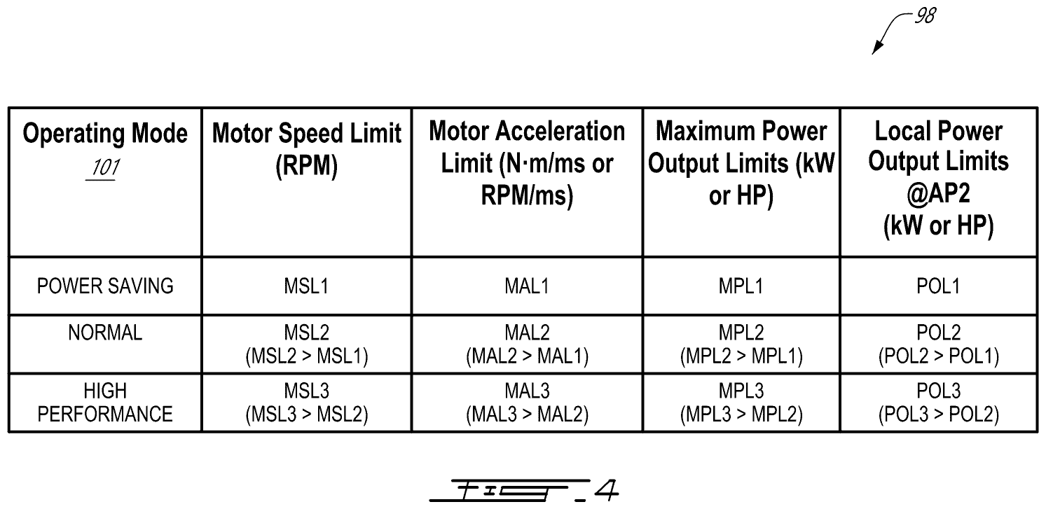

FIG. 4 is a table listing exemplary baseline operating parameters 98 that may be stored in memory 94 of controller 90. Controller 90 may use baseline operating parameters 98 to control the behaviour of watercraft 10 in accordance with the selected operating mode 101. In some embodiments, baseline operating parameters 98 may be stored in memory 94 in the form of one or more look-up tables and/or one or more mathematical relationships. Baseline operating parameters 98 may include factory-defined value(s) or dataset(s) defining factory-defined operating modes 101 of watercraft 10. Alternatively, or additionally, baseline operating parameters 98 may include user-defined value(s) or dataset(s) defining one or more user-defined operating modes 101, one or more user-defined performance characteristic(s), and/or one or more other operating parameters.

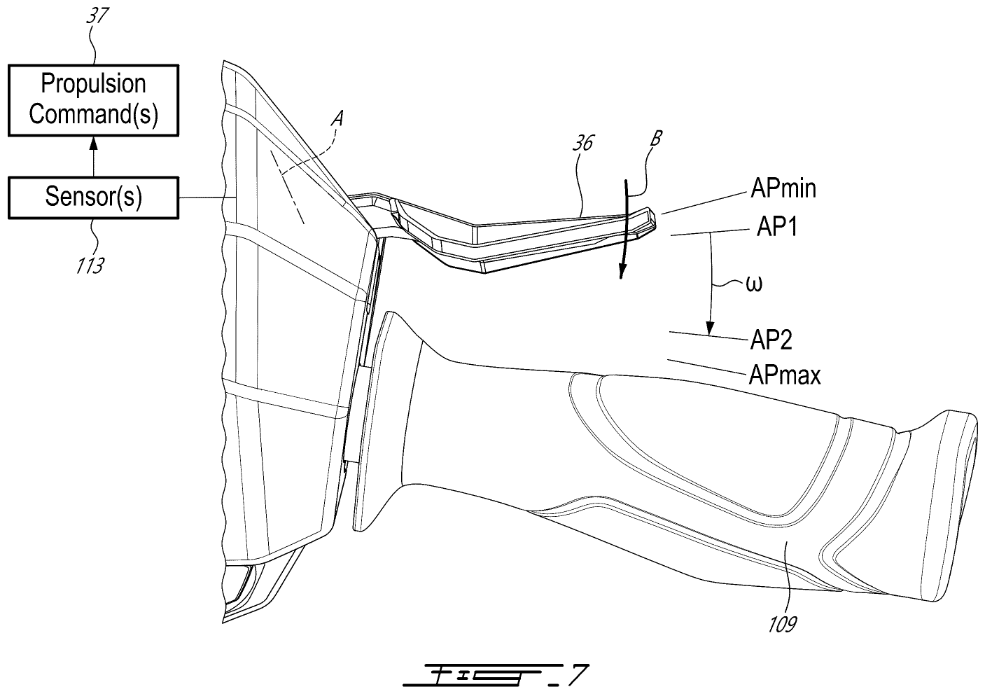

In some embodiments, such baseline operating parameters 98 may define motor speed limits (e.g., revolutions-per-minute (RPM)) MSL1-MSL3 for motor 50, motor acceleration limits (e.g., Newton-meter/millisecond or RPM/millisecond) MAL1-MAL3 for motor 50 and maximum power output limits MPL1-MPL3 (e.g., kilowatts (kW) or horsepower (HP)) associated with each operating mode for powertrain 40 and/or motor 50. Instead of motor speed limits, vehicle speed limits may be used and determined using a global positioning system (GPS) or a pitometer for example, and associated with the respective operating modes. Baseline operating parameters 98 may include other performance characteristics and/or restrictions such as torque output limits, torque curves associated with the actuation of accelerator 36, motor speed curves associated with the actuation of accelerator 36, and/or power curves associated with the actuation of accelerator 36 for different operating modes 101. For example, baseline operating parameters 98 may define local power output limits (POL1-POL3) associated with each operating mode for one or more accelerator positions such as second accelerator position AP2 shown in FIG. 7.

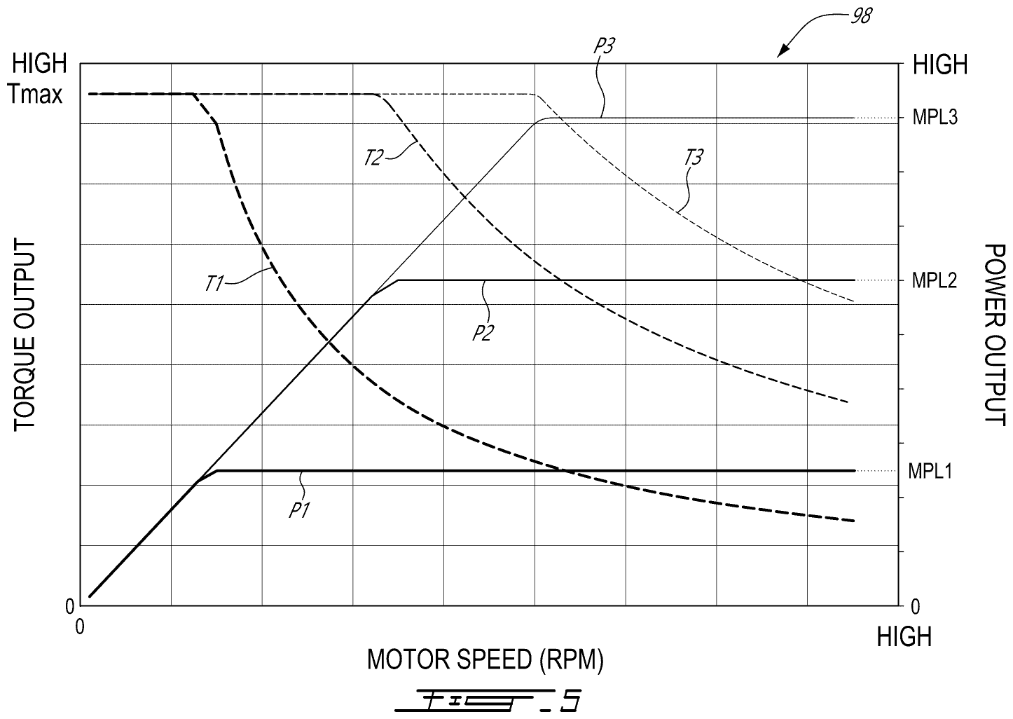

FIG. 5 is a graph showing in broken lines exemplary relationships T1-T3 of torque output from motor 50 as a function of the operating speed (RPM) of motor 50 associated with the power-saving, normal and high-performance operating modes respectively. FIG. 5 also concurrently shows in solid lines exemplary relationships P1-P3 of power output from motor 50 as a function of the operating speed (RPM) of motor 50 associated with the power-saving, normal and high-performance operating modes respectively. Relationships T1-T3 and/or P1-P3 may be defined by way of baseline operating parameters 98 and may be implemented by controller 90 based on the operating mode 101 selected at mode selector 103.

The power-saving operating mode may be the most restrictive and have the lowest maximum power output limit MPL1. The normal operating mode may be less restrictive and may have a higher maximum power output limit MPL2, which may provide more acceleration responsiveness than the power-saving operating mode. The high-performance operating mode may be the least restrictive and may have the highest maximum power output limit MPL3, which may provide more acceleration responsiveness than the normal operating mode. In some embodiments, all three operating modes 101 may impose the same maximum output torque limit Tmax that may be available from motor 50 as shown in FIG. 5. Aspects of the present disclosure may be applied to vehicles having one, two, three or more operating modes.

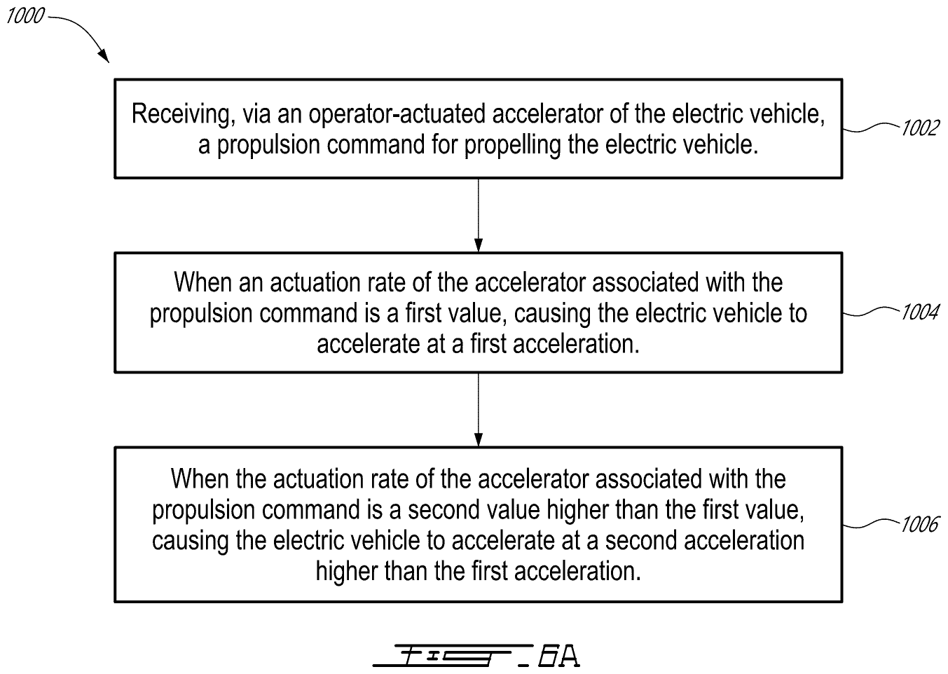

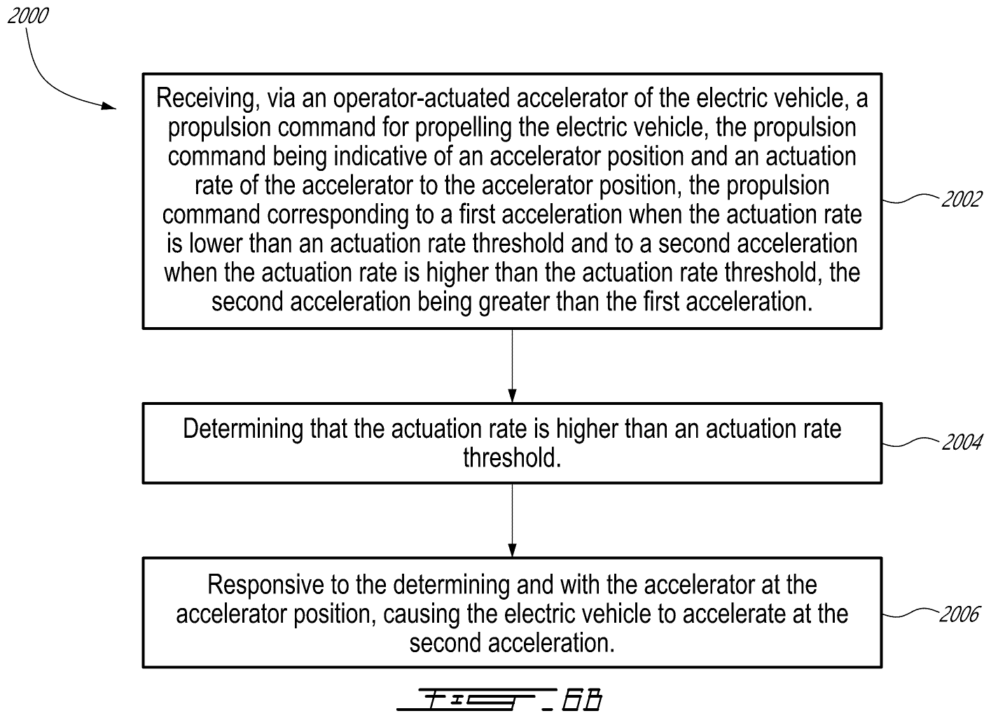

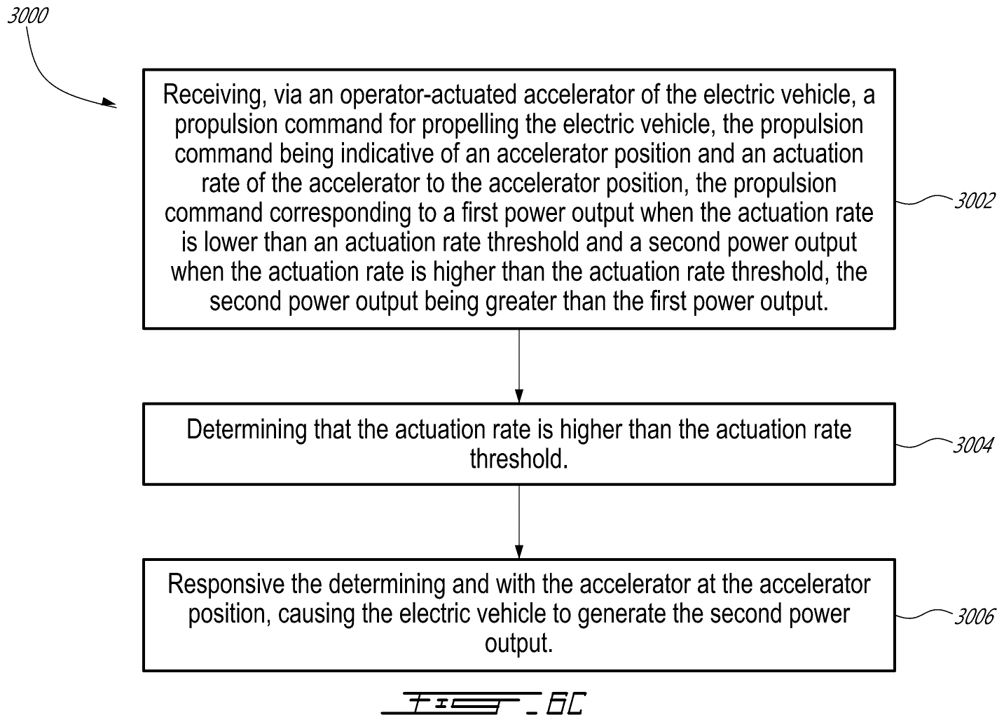

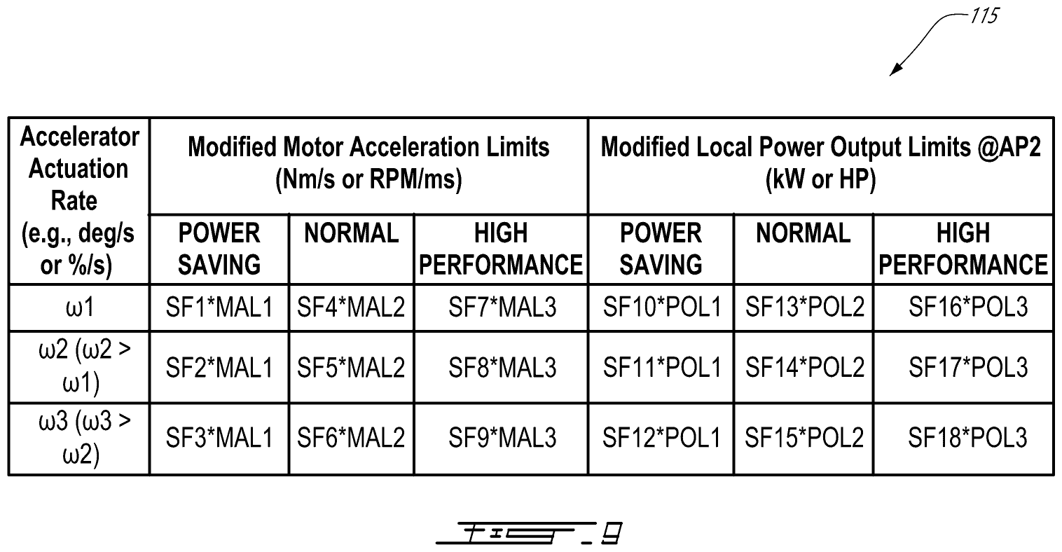

FIG. 6A is a flow diagram illustrating an exemplary method 1000 of operating an electric (e.g., powersport) vehicle such as watercraft 10 or snowmobile 100 as examples. Method 1000 may be performed using system 11 (shown in FIG. 3) described herein or using another system. Method 1000 may include other actions, elements of watercraft 10 or of snowmobile 100 and/or elements of system 11. In various embodiments, method 1000 may include:
receiving, via operator-actuated accelerator 36 of watercraft 10, propulsion command 37 for propelling watercraft 10, the propulsion command 37 being indicative of an accelerator position AP2 (shown in FIG. 7) and an actuation rate w (shown in FIG. 7) of accelerator 36 to accelerator position AP2 (block 1002);
with accelerator 36 at the accelerator position AP2, executing the propulsion command by: when actuation rate w (shown in FIG. 7) of accelerator 36 is a first value ω1 (shown in FIG. 9), causing watercraft 10 to accelerate at a first acceleration (block 1004); and when the actuation rate w of accelerator 36 is a second value ω2 (shown in FIG. 9) higher than the first value ω1 (i.e., ω2>ω1), causing watercraft 10 to accelerate at a second acceleration higher than the first acceleration (block 1006).

FIG. 6B is a flow diagram illustrating another exemplary method 2000 of operating an electric (e.g., powersport) vehicle such as watercraft 10 or snowmobile 100 as examples. Method 2000 may be performed using system 11 (shown in FIG. 3) described herein or using another system. Method 2000 may include other actions, elements of watercraft 10 or of snowmobile 100 and/or elements of system 11. In various embodiments, method 2000 may include:
receiving, via operator-actuated accelerator 36 of watercraft 10, propulsion command 37 for propelling watercraft 10, the propulsion command 37 being indicative of an accelerator position AP2 (shown in FIG. 7) and an actuation rate w (shown in FIG. 7) of accelerator 36 to the accelerator position AP2, the propulsion command 37 corresponding to a first acceleration when the actuation rate is lower than an actuation rate threshold and to a second acceleration when the actuation rate is higher than the actuation rate threshold, the second acceleration being greater than the first acceleration (block 2002);
determining that the actuation rate is higher than the actuation rate threshold (block 2004); and
responsive to the determining and with the accelerator at the accelerator position, causing watercraft 10 to accelerate at the second acceleration (block 2006).

FIG. 6C is a flow diagram illustrating another exemplary method 3000 of operating an electric (e.g., powersport) vehicle such as watercraft 10 or snowmobile 100 as examples. Method 3000 may be performed using system 11 (shown in FIG. 3) described herein or using another system. Method 3000 may include other actions, elements of watercraft 10 or of snowmobile 100 and/or elements of system 11. In various embodiments, method 3000 may include:
receiving, via an operator-actuated accelerator 36 of watercraft 10, propulsion command 37 for propelling watercraft 10, the propulsion command 37 being indicative of an accelerator position AP2 (shown in FIG. 7) and an actuation rate w (shown in FIG. 7) of accelerator 36 to the accelerator position AP2, the propulsion command 37 corresponding to a first power output when the actuation rate is lower than an actuation rate threshold and a second power output when the actuation rate is higher than the actuation rate threshold, the second power output being greater than the first power output (block 3002);
determining that the actuation rate is higher than the actuation rate threshold (block 3004); and
responsive the determining and with the accelerator at the accelerator position, causing watercraft 10 to generate the second power output (block 3006).

In various embodiments, methods 1000, 2000, 3000 may be used to command an acceleration (and/or power output) of watercraft 10 that is dependent on (e.g., as a function of) actuation rate w of accelerator 36. In methods 1000, 2000, 3000, how fast the operator actuates (e.g., pushes or pulls) accelerator 36 can be used to indicate the acceleration responsiveness desired by the operator. In some embodiments, methods 1000, 2000, 3000 may be used to exceed an acceleration responsiveness of watercraft 10 than would normally be available in the current operating mode, while remaining in the current operating mode. In other words, methods 1000, 2000, 3000 may be used to command a higher power output and speed from powertrain 40 of watercraft 10 than would normally be available in the current (e.g., power-saving or normal) operating mode. The use of the higher actuation rate w of accelerator 36 may be used to temporarily increase the responsiveness of watercraft 10 to mitigate a transient situation (e.g., getting on plane) of watercraft 10 without having to switch to a different (e.g., less restrictive) operating mode. The ability to command a higher power output via actuation rate w of accelerator 36 while remaining in the current operating mode instead of having to switch to a less restrictive operating mode may encourage operators to use the restrictive operating mode to promote reduced battery consumption and longer range for watercraft 10. Further aspects of methods 1000, 2000, 3000 are described below in relation to FIGS. 6-10.

FIG. 7 is a perspective view of an exemplary operator-actuated accelerator 36 disposed on a right-hand portion of the handlebar of watercraft 10. Accelerator 36 may be mounted to the handlebar of watercraft 10 adjacent right handgrip 109. Accelerator 36 may be a hand- (e.g., finger-) actuated lever pivotable about axis A. Alternatively, accelerator 36 may be a thumb-actuated lever or a foot-actuated pedal for example. Accelerator 36 may be resiliently biased with a spring toward an unactuated accelerator position AP min corresponding to a zero propulsion command.

In some embodiments, propulsion command 37 may include an absolute (e.g., angular) positions (e.g., degree) of accelerator 36 about axis A or a percentage of a full actuation range of accelerator 36. For example, unactuated accelerator position AP min may correspond to propulsion command 37 of 0% (nil) where no propulsion of watercraft 10 is being requested by the operator. Maximum accelerator position AP max may correspond to propulsion command 37 of 100% (i.e., fully actuated) where a maximum propulsion (e.g., torque, acceleration, speed) of watercraft 10 is being requested by the operator. The maximum propulsion (e.g. torque, acceleration, speed) available to watercraft 10 may be based on the selected operating mode 101 and/or an operating condition of watercraft 10.

During operation of watercraft 10, the operator may actuate accelerator 36 (e.g., displace accelerator 36 along arrow B) from first accelerator position AP1 to second accelerator position AP2 to generate propulsion command 37 and cause watercraft 10 to be propelled accordingly. First accelerator position AP1 may be any position that is equal to or greater than 0% associated with unactuated accelerator position AP min and that is below second accelerator position AP2. Second accelerator position AP2 may be any position that is greater than first accelerator position AP1 and up to 100% associated with maximum accelerator position AP max so that AP1<AP2<AP max.

The position of accelerator 36 may be sensed via one or more sensors(s) 113 (referred hereinafter in the singular) operatively connected to accelerator 36 and to controller 90. The sensed position(s) of accelerator 36 from sensor 113 may be communicated to controller 90. Sensor 113 may be a suitable (e.g., position) sensor for generating a signal indicative of the position of accelerator 36. For example, sensor 113 may be or a type suitable for drive-by-wire (e.g., throttle-by-wire) applications. In some embodiments, sensor 113 may be a linear or rotary position sensor. In various embodiments, sensor 113 may include a potentiometer or a Hall effect sensor for example.

Propulsion command 37 may be indicative of (e.g., include) a substantially current position of accelerator 36 such as second accelerator position AP2 and an actuation rate ω used by the operator to move accelerator 36 to second accelerator position AP2. The position of accelerator 36 may be provided to controller 90 substantially continuously or intermittently at prescribed intervals. For example, controller 90 may monitor a current position of accelerator 36 substantially in real time via sensor 113 so that actuation rate w may be determined at controller 90. For example, controller 90 may monitor a varying position of accelerator 36 sensed via sensor 113 and communicated to controller 90 as a series of consecutive positions of accelerator 36 over time as accelerator 36 is actuated. A displacement of accelerator 36 from first accelerator position AP1 to second accelerator position AP2 within an amount of time may be determined by controller 90. The displacement of accelerator 36 associated with propulsion command 37 may be expressed as AP2-AP1 (degrees or percentage). Actuation rate w (e.g., degrees/second or percent/second) of accelerator 36 and associated with propulsion command 37 may be determined by dividing the displacement of accelerator 36 by an amount of time taken to execute the displacement of accelerator 36 so that ω=(AP2-AP1)/time.

The displacement of accelerator 36 associated with propulsion command 37 may be determined by detecting a substantially continuous (i.e., uninterrupted) actuation of accelerator 36 spanning from first accelerator position AP1 to second accelerator position AP2. For example, first accelerator position AP1 may be identified by controller 90 as a starting position of accelerator 36 for the substantially continuous actuation of accelerator 36, and second accelerator position AP2 may be identified by controller 90 as an end/stopping position of accelerator 36 for the substantially continuous actuation of accelerator 36. Controller 90 may then execute propulsion command 37 while accelerator 36 remains at or sufficiently close to (e.g., within a prescribed threshold window of) second accelerator position AP2. The execution of the current propulsion command 37 may be terminated when a subsequent propulsion command 37 indicating a requested deceleration or further acceleration of watercraft 10 is received at controller 90. For example, the execution of the current propulsion command 37 may be terminated once accelerator 36 is determined to have been deliberately moved away from (e.g., no longer be within the prescribed positional threshold window of) second accelerator position AP2.

In some embodiments, the higher power output from powertrain 40 and/or the higher acceleration of watercraft 10 due to a higher actuation rate w may be commanded only when one or more conditions are met. For example, method 204 may enable watercraft 10 to be more responsive and exhilarating when accelerating from rest or low speed as watercraft 10 is accelerating toward the planing speed or the maximum speed. As such, watercraft 10 may include control logic to prevent the increase in power output and increased responsiveness to be activated when the watercraft 10 is already close to the planing speed, to the maximum speed of watercraft 10 or to the maximum power output (i.e., MPL3) of watercraft 10.

For example, causing watercraft 10 to accelerate at the higher acceleration may be conditional upon the displacement (i.e., AP2-AP1) of accelerator 36 being higher than a minimum displacement threshold. Such minimum displacement threshold may prevent the increase in power output and increased responsiveness to be activated when the watercraft 10 is already close to the planing speed or to the maximum speed of watercraft 10. In various embodiments, such minimum displacement threshold for accelerator 36 may be between 40% and 60% of the total actuation range 100% of accelerator 36 for example. In some embodiments, such minimum displacement threshold for accelerator 36 may be about 40%, about 45%, about 50%, about 55% or about 60% of the total actuation range 100% of accelerator 36 for example.

Alternatively or in addition, causing watercraft 10 to accelerate at the higher acceleration may be conditional upon first accelerator position AP1 being lower than a position threshold. Such position threshold may also prevent the increase in power output and increased responsiveness to be activated when the watercraft 10 is already close to the planing speed or to the maximum speed of watercraft 10. In various embodiments, such position threshold for accelerator 36 may be between 20% and 40%. In various embodiments, such position threshold for accelerator 36 may be about 20%, about 25%, about 30%, about 35% or about 40% for example.

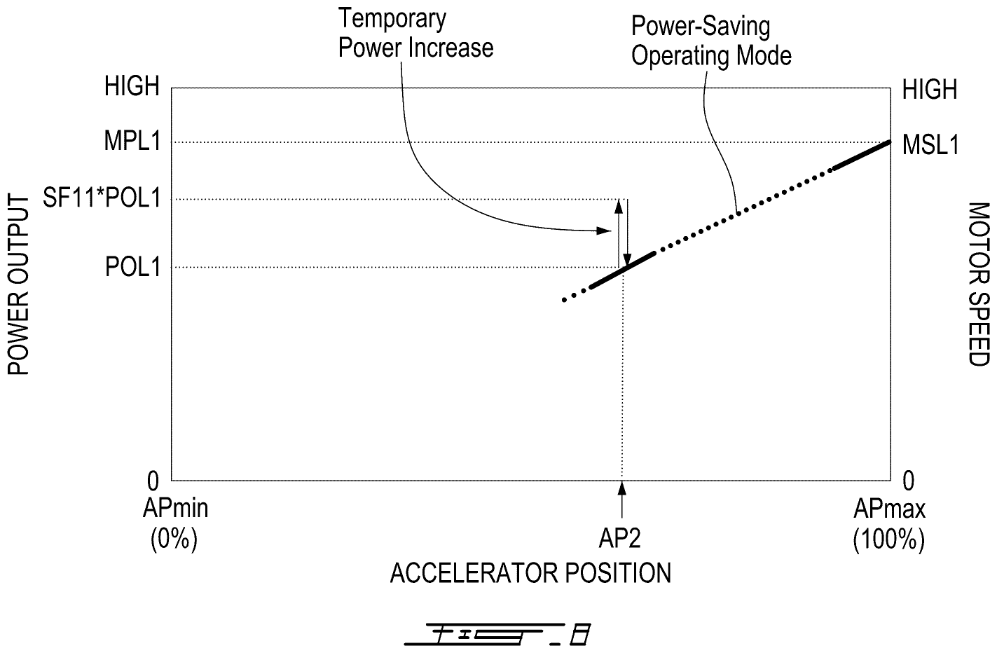

FIG. 8 is a graph showing an exemplary partial relationship between the commanded accelerator position AP2 of accelerator 36 and motor operating speed and also power output from powertrain 40. As explained above, propulsion command 37 may be mapped to the commanded operating speed (e.g., RPM) of motor 50 and controller 90 may then control powertrain 40 using the commanded motor operating speed. In some embodiments, a speed-to-power correlation may exist and be defined in a look-up table accessible by controller 90 so that controller 90 may instead or in addition control powertrain 40 using a commanded power output based on propulsion command 37. In some embodiments, propulsion command 37 may be mapped directly to the commanded power output (e.g., kW or HP) of motor 50 and controller 90 may then control powertrain 40 using the commanded power output.

For the sake of clarity in explaining the use of the temporary power increase, FIG. 8 shows partial motor speed mapping and a power output mapping for the power-saving operating mode on the same graph. In various embodiments, the mapping of accelerator position AP2 to the power output from powertrain 40 or to the motor speed may be linear or non-linear. The relationship between power output and motor speed may not be proportional across the entire actuation range of accelerator 36 and the power output mapping and the motor speed mapping may be plotted using separate lines in some embodiments. FIG. 8 shows exemplary performance characteristics of watercraft 10 associated with the power-saving operating mode but the temporary power increase shown in FIG. 8 and methods 1000, 2000, 3000 may also be applied when watercraft 10 is in the normal operating mode and/or in the high-performance operating mode.

In reference to methods 1000, 2000, 3000, when accelerator 36 is actuated from first accelerator position AP1 to second accelerator position AP2 at an actuation rate that is not sufficiently high to activate the temporary power increase that is beyond the power-saving relationship that is shown in FIG. 8, a power output from powertrain 40 corresponding to local power output limit POL1 applicable at second accelerator position AP2 may be commanded to cause acceleration of watercraft 10. However, when accelerator 36 is actuated from first accelerator position AP1 to second accelerator position AP2 at an actuation rate that is sufficiently high to activate the temporary power increase exceeding the power-saving relationship shown in FIG. 8, local power output limit POL1 may be temporarily exceeded to cause a higher acceleration of watercraft 10. In some embodiments, the magnitude of the power output exceedance represented by scaling factor SF11 may be a function of the actuation rate where a higher actuation rate causes a greater exceedance of the local power output limit POL1. For example, the actual power output may correspond to scaling factor SF11 multiplied by the baseline local power output limit POL1.

In situations where the temporary power increase is activated in a current (e.g., power-saving or normal) operating mode where the applicable maximum power output limit (e.g., MPL1 or MPL2) is lower than a maximum power output available from powertrain 40, the temporary power increase may exceed the applicable maximum power output limit (e.g., MPL1 or MPL2) depending on accelerator command 37. However, in situations where the temporary power increase is activated in a high-performance operating mode where the applicable maximum power output limit MPL3 corresponds to a maximum power output available from powertrain 40, the temporary power increase may exceed the local power output limit but may remain at or below maximum power output limit MPL3 depending on accelerator command 37.

During operation of watercraft 10, while accelerator 36 is at second accelerator position AP2 and a temporary power increase is activated, the power output from powertrain 40 may temporarily increase to SF11*POL1 until a condition or target is met and then may return to local power output limit POL1. In some embodiments, the condition may be watercraft 10 reaching a prescribed target (e.g., planing) speed or watercraft 10 exceeding a prescribed (e.g., planing) speed for example. In some embodiments, the condition may be a prescribed time duration of the temporary power increase being expired. The application of the temporary power increase may permit the mitigation of a transient condition of watercraft 10 while remaining in the current operating mode.

FIG. 9 is a table listing modified operating parameters 115 used to implement temporary power increases in three exemplary different operating modes of watercraft 10 as a function of accelerator actuation rate w. Modified operating parameters 115 may be stored in memory 94 of controller 90. Modified operating parameters 115 may include factory-defined value(s) or dataset(s). Alternatively, or additionally, modified operating parameters 115 may include user-defined value(s) or dataset(s).

Controller 90 may use modified operating parameters 115 to implement the temporary power increases when applicable. In some embodiments, modified operating parameters 115 may be stored in memory 94 in the form of one or more look-up tables and/or one or more mathematical relationships. Modified operating parameters 115 may include specific motor acceleration limits and/or specific local power output limits that are higher than corresponding values in baseline operating parameters 98. Modified operating parameters 115 may include scaling factors (i.e., gains) that are activated and applied to values stored as baseline operating parameters 98. In various embodiments, the temporary power increase may cause an increased acceleration (sometimes called “speed ramp rate”) and may be achieved through the use of an increased motor acceleration limit and/or an increased local power output limit.

In a power-saving operating mode for example, modified operating parameters 115 may include scaling factors SF1-SF3 respectively associated with accelerator actuation rates ω1-ω3, multiplied with the applicable motor acceleration limit MAL1 from baseline operating parameters 98. Similarly, scaling factors SF4-SF6 may be multiplied with the applicable baseline motor acceleration limit MAL2 for the normal operating mode, and scaling factors SF7-SF9 may be multiplied with the applicable baseline motor acceleration limit MAL3 for the high-performance operating mode.

Alternatively or in addition, in the power-saving operating mode, modified operating parameters 115 may include scaling factors SF10-SF12 respectively associated with accelerator actuation rates ω1-ω3, multiplied with applicable baseline local power output limit POL1. Similarly, scaling factors SF13-SF15 may be multiplied with the applicable baseline local power output limit POL2 for the normal operating mode, and scaling factors SF16-SF18 may be multiplied with the applicable baseline local power output limit POL3 for the high-performance operating mode.

In various embodiments, scaling factors SF1, SF4 and SF7 applicable against the respective motor acceleration limits MAL1-MAL3 for accelerator actuation rate ω1 may be identical to each other or different from each other. Scaling factors SF2, SF5 and SF8 applicable against the respective motor acceleration limits MAL1-MAL3 for accelerator actuation rate ω2 may be identical to each other or different from each other. Scaling factors SF3, SF6 and SF9 applicable against the respective motor acceleration limits MAL1-MAL3 for accelerator actuation rate ω3 may be identical to each other or different from each other.

In various embodiments, scaling factors SF10, SF13 and SF16 applicable against the respective local power output limits POL1-POL3 for accelerator actuation rate ω1 may be identical to each other or different from each other. Scaling factors SF11, SF14 and SF17 applicable against the respective local power output limits POL1-POL3 for accelerator actuation rate ω2 may be identical to each other or different from each other. Scaling factors SF12, SF15 and SF18 applicable against the respective local power output limits POL1-POL3 for accelerator actuation rate ω3 may be identical to each other or different from each other.

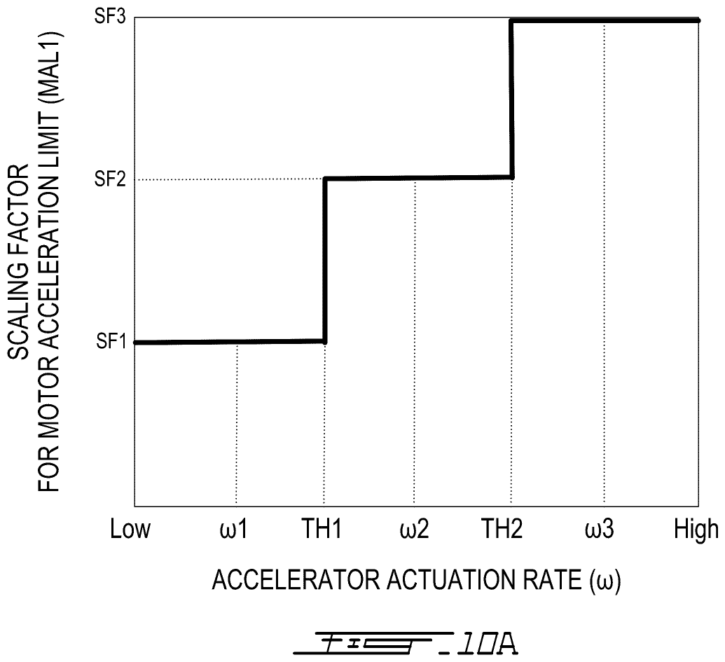

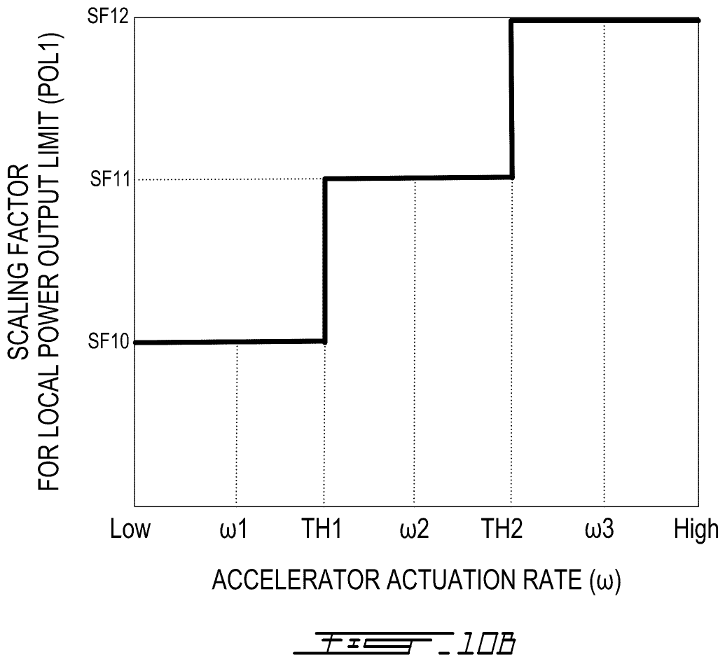

FIG. 10A is a graph showing an exemplary relationship of a scaling factor (gain) use to modify motor acceleration limit MAL1 as a function of accelerator actuation rate w in the power-saving operating mode. Similar relationships may be used to implement the temporary power increases in the normal operating mode and in the high-performance operating mode. The relationship may be linear or non-linear. In some embodiments, the relationship may be a step (i.e., staircase) function defining two or more intervals in which different scaling factors SF1-SF3 may be applicable, as shown in FIG. 10A. The relationship of FIG. 10A may be implemented via one or more actuation rate thresholds TH1 and TH2. For example, when propulsion command 37 has actuation rate ω1 lower than first actuation rate threshold TH1, watercraft 10 may be caused to accelerate at a first acceleration using the modified motor acceleration limit SF1*MAL1. In some implementations, SF1 is equal to 1.0. However, when propulsion command 37 has actuation rate ω2 higher than first actuation rate threshold TH1 and optionally lower than second actuation rate threshold TH2, watercraft 10 may be caused to accelerate at a second acceleration higher than the first acceleration using the modified motor acceleration limit SF2*MAL1 where SF2>SF1. In an embodiment where the relationship has a third interval, when propulsion command 37 has actuation rate ω3 higher than second actuation rate threshold TH2, watercraft 10 may be caused to accelerate at a third acceleration higher than the second acceleration using the modified motor acceleration limit SF3*MAL1 where SF3>SF2.

FIG. 10B is a graph showing an exemplary relationship of a scaling factor (gain) use to modify local power output limit POL1 as a function of accelerator actuation rate w in the power-saving operating mode. Similar relationships may be used to implement the temporary power increase in the normal operating mode and in the high-performance operating mode. The relationship may be linear or non-linear. In some embodiments, the relationship may be a step (i.e., staircase) function defining two or more intervals in which different scaling factors SF10-SF12 may be applicable, as shown in FIG. 10B. The relationship of FIG. 10B may be implemented via one or more actuation rate thresholds TH1 and TH2. For example, when propulsion command 37 has actuation rate ω1 lower than first actuation rate threshold TH1, watercraft 10 may be caused to accelerate at a first acceleration using the modified local power output limit SF10*POL1. In some implementations, SF10 is equal to 1.0. However, when propulsion command 37 has actuation rate ω2 higher than first actuation rate threshold TH1 and optionally lower than second actuation rate threshold TH2, watercraft 10 may be caused to accelerate at a second acceleration higher than the first acceleration using the modified local power output limit SF11*POL1 where SF2>SF1. In an embodiment where the relationship has a third interval, when propulsion command 37 has actuation rate ω3 higher than second actuation rate threshold TH2, watercraft 10 may be caused to accelerate at a third acceleration higher than the first acceleration using the modified local power output limit SF12*POL1 where SF3>SF2.

FIG. 11 is a graph showing three exemplary relationships R1-R3 of a motor operating speed versus time associated with three different respective accelerator actuation rates ω1, ω2 and ω3. The vehicle speed may be related to the motor operating speed. In case of the electric vehicle being watercraft 10, the temporary increase in power output in response to the higher accelerator actuation rate w may be used to accelerate watercraft 10 to reach a planing state more quickly. Since there can be variability in the speed at which watercraft 10 reaches the planing state and since there can be a subtle power drop when the planing state is reached, an active planing detection system may be difficult to implement. However, a suitable motor speed limit (e.g., MSL1) where watercraft 10 should have reached the planing state may be selected based on empirical data.

Relationship R1 associated with the low accelerator actuation rate ω1 may exhibit a low acceleration and may cause watercraft 10 to reach the planing state in the longest time and without substantially overshooting the commanded motor speed at which the planing state is reached. In some embodiments, accelerator actuation rate ω1 may be insufficient to activate the temporary power increase. In other words, accelerator actuation rate ω1 may activate a scaling factor of one (1.0) so that the values of baseline operating parameters 98 used by controller 90 to control powertrain 40 are not modified.

Relationship R2 associated with the intermediate accelerator actuation rate ω2 may exhibit a higher acceleration and may cause watercraft 10 to reach the planing state more quickly than relationship R1. Relationship R2 may exceed/overshoot the commanded motor speed at which the planing state is reached. After causing watercraft 10 to exceed the commanded speed and while accelerator 36 remains at second accelerator position AP2, watercraft 10 may be caused to decelerate to the commanded speed. The amount and duration of the overshoot may be selected to provide a relatively smoot entry into the planing state without a sudden change in acceleration. Accelerator actuation rate ω2 may be sufficiently high to activate the temporary power increase. In other words, accelerator actuation rate ω2 may activate a scaling factor greater than one (e.g., 1.1 or 1.2) so that the values of baseline operating parameters 98 used by controller 90 are modified accordingly to cause powertrain 40 to deliver the temporary power increase.

Relationship R3 associated with the higher accelerator actuation rate ω3 may exhibit a higher acceleration and may cause watercraft 10 to reach the planing state more quickly than relationship R2. Relationship R3 may also exceed/overshoot the commanded motor speed at which the planing state is reached. After causing watercraft 10 to exceed the commanded speed and while accelerator 36 remains at second accelerator position AP2, watercraft 10 may be caused to decelerate to the commanded speed. The amount and duration of the overshoot may be selected to provide a relatively smoot entry into the planing state without a sudden change in acceleration. Accelerator actuation rate ω3 may be sufficiently high to activate the temporary power increase. In other words, accelerator actuation rate ω3 may activate a scaling factor greater than one (e.g., 1.3 or 1.4) so that the values of baseline operating parameters 98 used by controller 90 are modified accordingly to cause powertrain 40 to deliver the temporary power increase to reach the planning state more quickly while remaining in the power-saving operating mode or the normal operating mode. The magnitude and/or duration of the overshoot may be selected based on accelerator actuation rate w so that higher accelerator actuation rate ω3 may result in a larger overshoot and/or an overshoot of a longer duration.

While FIG. 11 refers to a planing speed range applicable to watercraft 10, aspects of the present disclosure are also applicable to provide a temporary power increase to electric snowmobile 100 controlled based on commanded torque output instead of commanded speed, or to other types of electric vehicles.

In some embodiments, the application of the temporary power increase to electric snowmobile 100 may permit the mitigation of a transient condition where drive track 114 of the snowmobile is stuck in snow. The temporary increase in power output may permit the electric snowmobile 100 to build up track speed and break free of the snow while remaining in the power-saving operating mode or the normal operating mode, for example.

The embodiments described in this document provide non-limiting examples of possible implementations of the present technology. Upon review of the present disclosure, a person of ordinary skill in the art will recognize that changes may be made to the embodiments described herein without departing from the scope of the present technology.

1. A method of operating an electric vehicle, the method comprising:
receiving, via an operator-actuated accelerator of the electric vehicle, a propulsion command for propelling the electric vehicle, the propulsion command being indicative of an accelerator position and an actuation rate of the accelerator to the accelerator position, the propulsion command corresponding to a first acceleration when the actuation rate is lower than an actuation rate threshold and to a second acceleration when the actuation rate is higher than the actuation rate threshold, the second acceleration being greater than the first acceleration;
determining that the actuation rate is higher than the actuation rate threshold; and
responsive to the determining and with the accelerator at the accelerator position, causing the electric vehicle to accelerate at the second acceleration.

2. The method as defined in claim 1, wherein:
the electric vehicle is a watercraft;
the propulsion command is received when the watercraft is in an operating mode imposing a power output limit for a powertrain of the watercraft; and
causing the watercraft to accelerate at the second acceleration includes causing the powertrain of the watercraft to generate a power output higher than the power output limit while remaining in the operating mode.

3. The method as defined in claim 2, the first acceleration corresponds to a power output equal to or lower than the power output limit.

4. The method as defined in claim 1, wherein:
the actuation rate threshold is a first actuation rate threshold;
the propulsion command further corresponds to a third acceleration when the actuation rate of the accelerator is higher than a second actuation rate threshold higher than the first actuation rate threshold; and
the method includes determining that the actuation rate is lower than the second actuation rate threshold.

5. The method as defined in claim 1, wherein:
the accelerator position is indicative of a commanded speed of the electric vehicle; and
causing the electric vehicle to accelerate at the second acceleration includes causing the electric vehicle to exceed the commanded speed.

6. The method as defined in claim 5, comprising, after causing the electric vehicle to exceed the commanded speed and while the accelerator remains at the accelerator position, causing the electric vehicle to decelerate to the commanded speed.

7. The method as defined in claim 6, wherein:
the electric vehicle is a watercraft; and
the commanded speed of the watercraft is a planing speed of the watercraft.

8. The method as defined in claim 1, wherein:
the propulsion command includes a displacement of the accelerator from a first accelerator position to a second accelerator position; and
the method includes determining the actuation rate of the accelerator by dividing the displacement of the accelerator by an amount of time taken to execute the displacement of the accelerator.

9. The method as defined in claim 1, wherein:
the propulsion command includes a displacement of the accelerator from a first accelerator position to a second accelerator position; and
causing the electric vehicle to accelerate at the second acceleration is conditional upon the displacement of the accelerator being higher than a displacement threshold.

10. The method as defined in claim 1, wherein:
the propulsion command includes a displacement of the accelerator from a first accelerator position to a second accelerator position; and
causing the electric vehicle to accelerate at the second acceleration higher than the first acceleration is conditional upon the first accelerator position being lower than a position threshold.

11. The method as defined in claim 9, comprising determining the actuation rate of the accelerator by dividing the displacement of the accelerator by an amount of time taken to execute the displacement of the accelerator.

12. The method as defined in claim 1, wherein the electric vehicle is a personal watercraft.

13. A computer program product for controlling an operation of an electric powersport vehicle, the computer program product comprising a non-transitory computer readable storage medium having program code embodied therewith, the program code readable and executable by a computer, processor or logic circuit to perform the method as defined in claim 1.

14. A system for operating an electric vehicle, the system comprising:
an accelerator actuatable by an operator of the electric vehicle to generate a propulsion command including an accelerator position and an actuation rate of the accelerator to the accelerator position; and
one or more controllers operatively connected to the accelerator and to a powertrain of the electric vehicle, the one or more controllers being configured to:
receive the propulsion command;
with the accelerator at the accelerator position, execute the propulsion command by:
when the actuation rate of the accelerator is a first value, cause the powertrain of the electric vehicle to generate a first power output to accelerate the electric vehicle; and
when the actuation rate of the accelerator is a second value higher than the first value, cause the powertrain of the electric vehicle to generate a second power output to accelerate the electric vehicle, the second power output being higher than the first power output.

15. The system as defined in claim 14, wherein when the propulsion command is received when the electric vehicle is in an operating mode imposing a power output limit for the powertrain of the electric vehicle, the second power output is higher than the power output limit.

16. The system as defined in claim 15, wherein when the propulsion command is received when the electric vehicle is in the operating mode imposing the power output limit for the powertrain of the electric vehicle, the first power output is equal to or lower than the power output limit.

17. The system as defined in claim 14, wherein:
the accelerator position is indicative of a commanded operating speed of an electric motor configured to propel the electric vehicle; and
causing the powertrain of the electric vehicle to generate the second power output to accelerate the electric vehicle includes causing the electric motor to exceed the commanded operating speed while executing the propulsion command.

18. The system as defined in claim 17, wherein the one or more controllers are configured to, after causing the electric motor to exceed the commanded operating speed, causing the electric motor to decelerate to the commanded operating speed while executing the propulsion command.

19. A watercraft or a snowmobile comprising the system as defined in any-ee-ef claim 14.

20. An electric vehicle comprising:
a powertrain including an electric motor for propelling the electric vehicle and a battery operatively connected to drive the electric motor;
an accelerator actuatable by an operator of the electric vehicle;
one or more controllers operatively connected to the powertrain and to the accelerator, the one or more controllers being configured to:
receive a propulsion command via the accelerator, the propulsion command being indicative of an accelerator position and an actuation rate of the accelerator to the accelerator position;
with the accelerator at the accelerator position, executing the propulsion command by:
when the actuation rate of the accelerator is a first value, command the powertrain of the electric vehicle to generate a first power output to accelerate the electric vehicle; and
when the actuation rate of the accelerator is a second value higher than the first value, command the powertrain of the electric vehicle to generate a second power output to
accelerate the electric vehicle, second power output being higher than the first power output.

21.-29. (canceled)
